(19) United States
(12) Patent Application Publication
(10) Pub. No.: US 2013/0235309 A1
(43) Pub. Date: Sep. 12, 2013

(54) CONTINUOUS POLYMER FILM PRODUCTION METHOD, POLYMER FILM, LAMBDA/4 PLATE, POLARIZING PLATE, AND LIQUID CRYSTAL DISPLAY DEVICE

(71) Applicants: Midori Kogure, Tokyo (JP); Takeshi Tanaka, Tokyo (JP)

(72) Inventors: Midori Kogure, Tokyo (JP); Takeshi Tanaka, Tokyo (JP)

(73) Assignee: KONICA MINOLTA , INC., Tokyo (JP)

(21) Appl. No.: 13/880,178

(22) PCT Filed: Oct. 20, 2011
(86) PCT No.: PCT/JP2011/005887

§ 371 Date: Apr. 18, 2013

(30) Foreign Application Priority Data
Oct. 21, 2010 (JP) 2010-236251

(51) Int. Cl. B29D 7/01; G02B 5/30

(52) U.S. Cl. CPC B29D 7/01; G02B 5/3025
USPC 349/96; 156/157; 156/73.4; 156/64; 359/492.01

(57) ABSTRACT

A method for producing a continuous polymer film includes: (1) overlapping and bonding the rear end section of a preceding raw film and the front end section of a following raw film, along a bonding line; and (2) supporting both end sections by means of a plurality of gripping tools and obliquely stretching the bonded raw film while conveying the bonded raw film in order to produce a polymer film. In the bond between the rear end section of the preceding raw film and the front end section of the following raw film, the angle (φ1) between the bonding line for the polymer film and the width direction of the polymer film and the angle (θ1) between the in-plane slow axis of the polymer film and the width direction of the polymer film fulfill formula (I).

|φ1−θ1|≦10° Formula (I):.

### TECHNICAL FIELD

The present invention relates to a method for producing a long-sized polymer film which limits the generation of twitch or rupture and enables continuous oblique stretching, and a long-sized polymer film produced by the production method.

### BACKGROUND ART

Conventionally, various types of polymer films used in optical applications are often produced by the solution or melt casting method. In the solution casting method, basically, a dope is cast on a support by using a casting die; after the formation of the cast film, the film is peeled off the support, and thereafter is subjected to drying to make a film. Then, the obtained film is taken up on a winding core to provide a film roll.

In order to improve thickness, flatness, mechanical strength, optical characteristics and the like of a film, the production method typically involves stretching the film either longitudinally or transversely.

However, in the case where a polymer film functioning as a λ/4 plate is produced by the solution casting method and then a polarizer stretched in the longitudinal direction and the λ/4 plate are laminated in roll-to-roll in a later step of making a polarizing plate, the λ/4 plate needs to be stretched in an oblique direction (hereinafter, referred to as “oblique stretching”). When the oblique stretching is carried out, in order to fabricate a film having better mechanical strength and flatness, making the stretching speed equal to the film-formation speed is not appropriate in some cases. It is therefore desirable that the stretching is carried out in a stretching line that is separate from the solution casting film-formation line (hereinafter, referred to as “off-line stretching”) (refer to Patent Document No. 1).

As described in Patent Literature 1, it is preferable that in order to efficiently carry out the off-line stretching, a film is continuously stretched. Therefore, in the case where the off-line stretching is carried out for one film roll, it is needed that the front end portion of a following film delivered from the film roll is joined to the rear end portion of a preceding film delivered from the film roll.

As joining methods in such a case, methods are conventionally known which use a joining tape, thermal fusion, ultrasonic fusion, laser fusion and the like (refer to Patent Document Nos. 2 to 5).

### PRIOR ART LITERATURES

### Patent Documents

### Patent Document 1

Japanese Patent O.P.I. Publication No. 2002-311240

### Patent Document 2

Japanese Patent O.P.I. Publication No. 2009-90651

### Patent Document 3

Japanese Patent O.P.I. Publication No. 2009-90650

### Patent Document 4

Japanese Patent O.P.I. Publication No. 2008-238682

### Patent Document 5

Japanese Patent O.P.I. Publication No. 2008-238678

### SUMMARY OF THE INVENTION

### Problems to be Solved by the Invention

However, it has been found that although the conventional joining methods can be adapted to the stretching in the transverse direction (TD), they cannot be adapted to the oblique stretching. For example, if the joining is carried out by using a conventional joining tape and the oblique stretching is carried out, a problem is that a twitch is generated and a rupture is liable to be causing. Twitch is considered to be generated because the ease of elongation and the mechanical strength of a pressure-sensitive adhesive agent of a joining tape are different from those of the film.

The present inventors have attempted a joining method without using a joining tape. However, it has been found that also in the case where the joining is carried out by thermal fusion, the generation of twitch cannot sufficiently be limited and the productivity is poor due to much time being taken for the condition establishment. It has also been found that in the case of thermal fusion, a fused portion (joining line) is liable to become broad and the thickness of the fused portion becomes nearly two times the average film thickness of a film, thereby causing twitch and then causing rupture.

The present invention has been achieved in consideration of the above-mentioned problems and situations, and object thereof is to provide a method for producing a long-sized polymer film which can limit the generation of twitch or rupture and enables the continuous oblique stretching. Another problem thereof is to provide a long-sized polymer film generating no twitch and no rupture. “Twitch” as used herein refers to a defect in which a polymer film undulates in a corrugated galvanized sheet shape around a joining portion.

### Means for Solving the Above Problems

The above-mentioned problems relevant to the present invention are solved by the following means.

[1] A method for producing a long-sized polymer film, comprising: (1) overlapping and joining the rear end portion of a preceding raw film and the front end portion of a following raw film along a joining line; (2) heating the joined raw film, supporting both end portions thereof by a plurality of holding implements and obliquely stretching the raw film under continuous conveyance of the raw film to thereby make a polymer film; and (3) subjecting the polymer film to a heat treatment for stress relaxation under continuous conveyance of the polymer film, wherein the oblique stretching is carried out so that the angle formed by the in-plane slow axis of the polymer film obtained after the oblique stretching and the transverse direction of the polymer film obtained after the oblique stretching is in the range of 40 to 50°, and the joining of the rear end portion of the preceding raw film and the front end portion of the following raw film is carried out so that the angle φ₁ formed by the joining line of the polymer film and the transverse direction of the polymer film and the angle θ₁ formed by the in-plane slow axis of the polymer film and the transverse direction of the polymer film satisfy the following equation (1).

|φ₁−θ₁|≦10° Equation (1):

[2] The method for producing a long-sized polymer film according to [1], wherein the angle formed by the joining line of the raw film and the transverse direction of the raw film is made in the range of larger than −10° and 25° or smaller.

[3] The method for producing a long-sized polymer film according to [1] or [2], in which the width of the joining line of a joining portion of the rear end portion of the preceding raw film and the front end portion of the following raw film is 5 mm or smaller.

[4] The method for producing a long-sized polymer film according to any of [1] to [3], in which the total thickness of the joining portion of the rear end portion of the preceding raw film and the front end portion of the following raw film is within 1.1 to 1.5 times the average film thickness of the raw films.

[5] The method for producing a long-sized polymer film according to any of [1] to [4], in which the rear end portion of the preceding raw film and the front end portion of the following raw film are joined by fusion using an ultrasonic vibration.

[6]A polymer film produced by a method for producing a long-sized polymer film according to any of [1] to [5], in which the in-plane retardation value Ro(550) measured under an environment of 23° C. and 55% RH and at a wavelength of 550 nm is in the range of 110 to 170 nm.

[7] A λ/4 plate including the polymer film according to [6].

[8] A polarizing plate including a polarizer and a polymer film according to [6] disposed on at least one surface of the polarizer.

[9] A liquid crystal display including a liquid crystal cell and a pair of polarizing plates interposing the liquid crystal cell, in which at least one of the pair of polarizing plates includes a polarizer and the polymer film according to [6] disposed on at least one surface of the polarizer.

### (Advantageous) Effects of the Invention

The above-mentioned means according to the present invention can provide a method for producing a long-sized polymer film which can limit the generation of twitch or rupture and enables the continuous oblique stretching. The above-mentioned means according to the present invention can also provide a long-sized polymer film generating no twitch and no rupture.

### BRIEF DESCRIPTION OF THE DRAWINGS

FIG. 1 is a conceptual diagram of one example of an off-line stretching apparatus;

FIG. 2 is a conceptual diagram of one example of an oblique stretching machine in a center section;

FIG. 3A is a conceptual diagram illustrating a joining portion of a film before stretching; and

FIG. 38 is a conceptual diagram illustrating a joining portion of a film after stretching.

### EMBODIMENTS OF THE INVENTION

Hereinafter, the present invention, constituent elements thereof, and embodiments and modes according to the present invention will be described in detail. Herein, the term “to” between numerical values is used in a meaning including the numerical values described before and after the “to” as a lower limit value and an upper limit value.

(Outline of a Method for Producing a Long-Sized Polymer Film)

A method for producing a long-sized polymer film according to the present invention includes: (1) overlapping and joining the rear end portion of a preceding raw film and the front end portion of a following raw film along a joining line (joining step); (2) heating the joined raw film, supporting both edge portions thereof by a plurality of holding implements and obliquely stretching the raw film under continuous conveyance of the raw film to thereby make a polymer film (stretching step); and (3) subjecting the polymer film to a heat treatment for stress relaxation under continuous conveyance of the polymer film (thermal relaxation step), wherein the oblique stretching is carried out so that the angle formed by the in-plane slow axis of the polymer film obtained after the oblique stretching and the transverse direction of the polymer film obtained after the oblique stretching is in the range of 40 to 50°, and the joining of the rear end portion of the preceding raw film and the front end portion of the following raw film is carried out so that the angle φ₁ formed by a joining line of the polymer film and the transverse direction of the polymer film and the angle θ₁ formed by the in-plane slow axis of the polymer film and the transverse direction of the polymer film satisfy the following equation (1). As used herein, a polymer film refers to a film obtained after a raw film is obliquely stretched.

As used herein, a “joining line” refers to a line which is positioned between a line forming an end of the rear end portion of a preceding film and a line forming an end of the front end portion of a following film, and where both the films are actually joined by a tape or fusion.

In the present invention, from the viewpoint of prevention of twitch generation, the joining strength and the like, the width of a joining line of a joining portion of the rear end portion of the preceding raw film and the front end portion of the following raw film is within 5 mm, and preferably within 2 mm.

From the viewpoint of the stress generated during stretching, the prevention of twitch generation and the like, it is preferable that the total thickness of a joining portion of the rear end portion of a preceding raw film and the front end portion of a following raw film is within 1.1 to 1.5 times the average film thickness of a polymer film.

It is also preferable that the rear end portion of a preceding raw film and the front end portion of a following raw film are joined by fusion using an ultraviolet vibration.

In the method for producing a long-sized polymer film according to the present invention, the stretching is carried out by a stretching line separated from a film-formation line (hereinafter, referred to as “off-line stretching”).

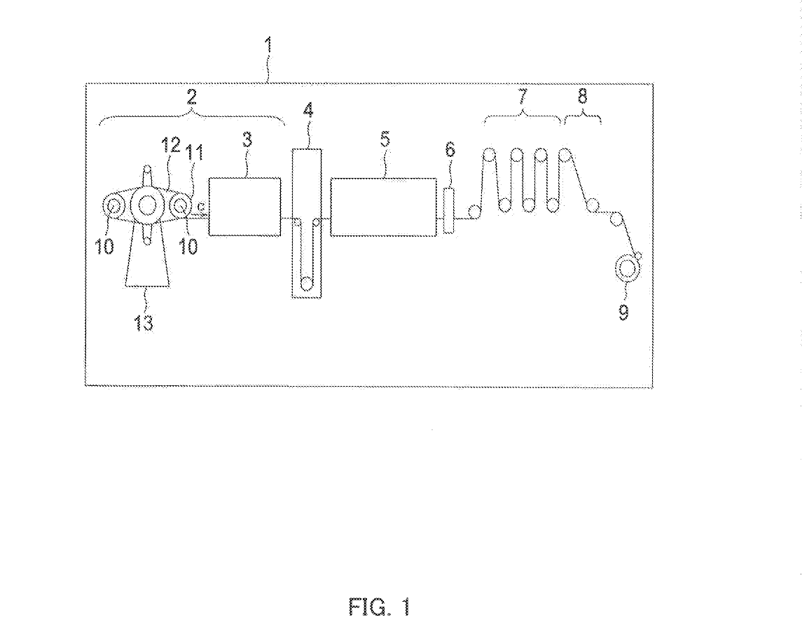

Hereinafter, with reference to an overall diagram of one example of an off-line stretching apparatus to be used in the off-line stretching (FIG. 1), a method for producing a long-sized polymer film will be outlined.

(Off-Line Stretching Apparatus)

Off-line stretching apparatus 1 illustrated in FIG. 1 stretches a polymer film, and has film feed section 2, accumulation section (abbreviation for “accumulator section”) 4, tenter section 5, trimming apparatus 6, thermal relaxation section 7, cooling section 8, and takeup section 9; and these are disposed in order along the film conveyance direction c.

Film feed section 2 has film roll 11 produced by a film-formation facility. Film roll 11 is a film roll obtained by taking up a raw film on a winding core into a roll shape. A raw film is delivered from film roll 11 which film feed section 2 has, and is stretched in the oblique direction under heating in tenter section 5 to thereby make a polymer film. The obtained polymer film is cooled through thermal relaxation section 7 and cooling section 8, and taken up by takeup section 9. In film feed section 2, tenter section 5, thermal relaxation section 7, cooling section 8, and takeup section 9, EPCs (edge position controllers) to perform control for the accurate conveyance by limiting meandering of the film are provided. The EPCs are not illustrated in the drawing.

<Film Feed Section>

Film feed section 2 has turret type film delivery apparatus 13 and joining section 3. Film delivery apparatus 13 has turret arm 12 whose both ends are provided each with mounting shaft 10. Each mounting shaft 10 is installed with film roll 11. Turret arm 12 rotates by 180°, and makes one mounting shaft 10 positioned at a delivery position (on the side of joining area 3), and the other mounting shaft 10 positioned at a winding core-exchange position. The raw film is delivered from film roll 11 installed on mounting shaft 10 at the delivery position to joining area 3. When the entire of the raw film is delivered, turret arm 12 rotates; and an empty winding core is dismounted from mounting shaft 10 positioned at the winding core-exchange position, and a fresh film roll is installed.

<Joining Area>

In joining area 3, in order to feed a continuous raw film to tenter section 5, the rear end portion of the precedingly delivered raw film and the front end portion of the followingly delivered raw film are overlapped and joined.

<Accumulation Section>

Accumulation section (abbreviation for “accumulator section”) 4 is disposed between film feed section 2 and tenter section 5, and forms a loop of the raw film equal to or longer than a length necessary for a joining treatment of the raw film. Therefore, at the time of joining the raw film, since the raw film accommodated in accumulation section 4 is delivered to tenter section 5, the joining treatment of the raw film can be carried out without suspending tenter section 5.

<Tenter Section>

A tenter of tenter section 5 is an apparatus to widen the width of the long-sized raw film in the oblique direction with respect to the traveling direction thereof (the moving direction of the midpoint in the film width direction) under a heating environment by an oven. The tenter has the oven, a pair of rails on the right and left sides where holding implements to convey the film travel, and a large number of the holding implements traveling on the rails.

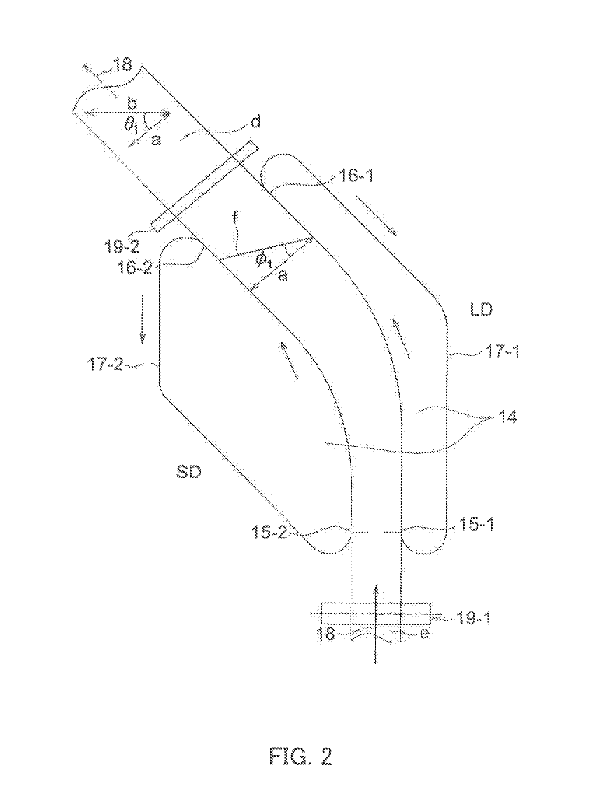

FIG. 2 is a conceptual diagram illustrating one example of an oblique stretching machine in tenter section 5. As illustrated in FIG. 2, the raw film reeled out from the film roll is conveyed by inlet-side guide roll 19-1 of the tenter, and successively fed to an inlet part of tenter 14. The fed raw film is held on its both end portions by the holding implements, introduced into the oven, and is released from the holding implements at an outlet part of tenter 14. The film released from the holding implements is conveyed by outlet-side guide roll 19-2 of the tenter, and taken up on the winding core. The pair of rails each have an endless continuous track; and the raw film is held at LD-side film-holding starting-point 15-1 and SD-side film-holding starting-point 15-2 of the inlet part of tenter 14, and thereafter released at LD-side film-holding finishing-point 16-1 and SD-side film-holding finishing-point 16-2 of the outlet part of tenter 14. The holding implements having released the holding of the raw film are designed to travel on the outer sides along track 17-1 of an LD-side film holding section and track 17-2 of an SD-side film holding sections, separately, and successively return to the inlet part of tenter 14. In the figure, reference numeral 18 indicates the feeding direction of the film.

The rail shapes of the tenter are right-left asymmetric depending on the in-plane orientation angle, the stretching ratio and the like of a polymer film to be produced, and are designed to be finely adjusted either manually or automatically.

In the present invention, the stretching direction when a raw film is obliquely stretched is designed to be set so that the in-plane orientation angle θ₁ of a polymer film to be obtained after oblique stretching is preferably in the range of 10 to 80°, and more preferably in the range of 40 to 50°, with respect to the transverse direction of the polymer film to be obtained after the oblique stretching. In the present invention, the holding implements of the tenter are designed to travel at a constant velocity with constant intervals held between front and rear holding implements.

The stretching ratio in the oblique direction of a raw film is preferably 0.5 to 3 times, and more preferably 1.5 to 2.5 times. The stretching temperature can be made to be about 140 to 210° C.

The traveling velocity of the holding implements can suitably be selected, but is usually 10 to 100 m/min. The difference in traveling velocity between a right-left pair of holding implements is usually 1% or lower, preferably 0.5% or lower, and more preferably 0.1% or lower of the traveling velocity. This is because if there is a difference in traveling velocity between the right and the left of the film at the stretching step outlet, since wrinkles and offsets are generated at the stretching step outlet, the velocity difference between right and left holding implements is required to be substantially zero. Although in general tenter apparatuses and the like, velocity fluctuations occur, which are often several percent in the subsecond order depending on the period of teeth of a sprocket to drive a chain, the frequency of a drive motor and the like, these do not correspond to the velocity difference as used in the present invention.

In the oblique stretching tenter to be used in the present invention, it is preferable that the positions of each rail part and rail junction part can be freely set; therefore, if any inlet width and outlet width are set, a stretching ratio corresponding to these can be made.

In the oblique stretching tenter to be used in the present invention, a large bending curvature is often required for the rails to control the tracks of the holding implements. For the purpose of avoiding the interference between holding implements or the local stress concentration due to sharp bending, it is desirable that the tracks of the holding implements form circular arcs at bending parts.

<Trimming Apparatus>

The polymer film obtained by being stretched by tenter section 5 is delivered to trimming apparatus 6. Both side edge portions of the polymer film are cut off by trimming apparatus 6, and the trimmed wastes being the cut-off slit-like side edge portions are cut into fine pieces by a cut blower. The cut trimmed waste pieces are fed to a crusher by an air-feeding apparatus, and crushed into chips. The chips are reutilized for preparation of a dope.

In the case where a preceding raw film and a following raw film are joined by a joining tape, since the tape needs to be removed from the trimmed wastes for the reutilization, much time and labor is taken, which is not preferable. In the case where the joining is carried out by thermal fusion or ultrasonic fusion, the joined raw film can be reutilized as it is in the jointed state. The polymer film whose both side edge portions have been cut off by trimming apparatus 6 is fed to thermal relaxation section 7.

<Thermal Relaxation Section>

Thermal relaxation section 7 has a large number of rollers, and the polymer film is conveyed in thermal relaxation section 7 by the rollers. In thermal relaxation section 7, air at a desired temperature is fed from an air blower to thereby subject the polymer film to a heat treatment. The temperature of the air at this time is preferably 20 to 250° C.

<Cooling Section and Takeup Section>

The polymer film after the thermal relaxation is fed to cooling section 8 to cool the polymer film to 30° C. or lower, and then fed to takeup section 9. The interior of takeup section 9 is provided with a takeup roller and a press roller. The film fed to takeup section 9 is taken up by the takeup roller. At this time, the film is pressed by the press roller and taken up.

(Film Shapes of a Joining Portion Before and after Stretching)

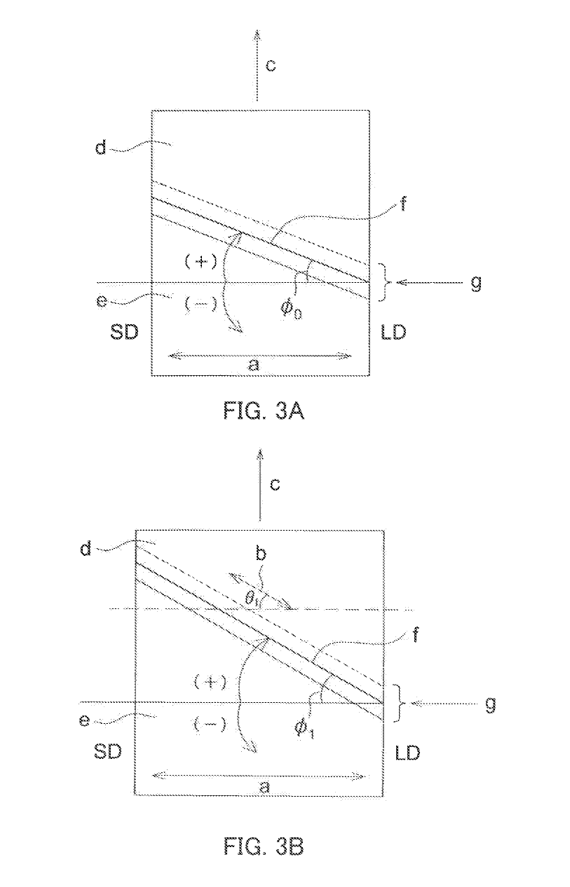

In the present invention, the rear end portion of a preceding raw film and the front end portion of a following raw film are overlapped and joined, and the joined raw film is heated and supported on both end portions thereof and obliquely stretched by a plurality of holding implements under continuous conveyance of the raw film. It is preferable that the stretching in the oblique direction of the raw film is carried out so that the angle formed by the in-plane slow axis (b) of the polymer film obtained after the oblique stretching and the transverse direction (a) of the polymer film obtained after the oblique stretching is in the range of 40 to 50°, as described above. The joining of the rear end portion of the preceding raw film and the front end portion of the following raw film is carried out so that the angle φ₁ formed by a joining line of a polymer film to be obtained and the transverse direction of the polymer film and the angle θ₁ formed by the in-plane slow axis and the transverse direction of the polymer film satisfy the equation (1): |φ₁−θ₁|≦10°. This feature will be described with reference to FIGS. 3A and 3B.

FIG. 3A is a conceptual diagram illustrating a shape of a joining portion of a film before stretching. FIG. 3B is a conceptual diagram illustrating a shape of a joining portion of a film after stretching. As illustrated in FIG. 3B, the rear end portion of a preceding raw film and the front end portion of a following raw film are joined so that the angle φ₁ formed by a joining line (f) of a polymer film and the transverse direction (a) of the polymer film and the angle θ₁ formed by the in-plane slow axis (b) and the transverse direction (a) of the polymer film satisfy the above equation (1).

The joining line (f) of a joining portion (g) refers to a line which is positioned between a line forming an end of the rear end portion of the preceding raw film (d) and a line forming an end of the front end portion of the following raw film (e), and where both the films are actually joined by a tape or fusion.

The in-plane slow axis (b) refers to an axis along the direction in which the refractive index reaches a maximum in the plane of the polymer film. The in-plane slow axis (b) can be measured simultaneously with the in-plane retardation value Ro of the polymer film by a commercially available automatic birefringence analyzer (e.g., AxoScan, made by Axometrics. Inc., KOBRA-21ADH).

The signs of the angle φ₀ formed by the joining line (f) of a raw film and the transverse direction (a) of the raw film, and the angle θ₁ formed by the joining line (f) of a polymer film and the transverse direction (a) of the polymer film, in the case where the film is viewed such that with the transverse direction (a) being taken to be 0°, the small turn side (SD) of the oblique stretching apparatus illustrated in FIG. 2 is left; the large turn side (LD) thereof is right; and the film conveyance direction is up, are defined to be plus in the case where the joining line (f) directs from upper left toward lower right, and to be minus in the case where the joining line (f) directs from upper right toward lower left (hereinafter, the sign means plus in the case where no specific sign is stated).

The angle (φ₁) formed by the joining line (f) of the polymer film and the transverse direction (a) of the polymer film, though depending on the angle (θ₁) formed by the in-plane slow axis (b) of the polymer film and the transverse direction (a) of the polymer film, is preferably in the range of 30 to 60°, more preferably in the range of 35 to 55°, and still more preferably equal to θ₁.

If φ₁ and θ₁ are largely different, the stress impressed on the film at the time of stretching is produced in the direction crossing the joining line. Therefore, the difference between the deformation amount of the film in the joining portion and the deformation amount of the film around the joining portion becomes large, and rupture and twitch of the film around the joining portion is liable to be generated. By contrast, if φ₁ is near to θ₁, the stress impressed on the film at the time of stretching is easily produced in the direction parallel to the joining line. Therefore, the difference between the deformation amount of the film in the joining portion and the deformation amount of the film around the joining portion becomes small, and rupture and twitch of the film around the joining portion can be limited.

In order to make φ₁ take such an angle, the angle θ₀ formed by the joining line (f) of the raw film before stretching and the transverse direction (a) of the raw film is adjusted for joining. Specifically, the angle φ₀ formed by the joining line (f) of the raw film and the transverse direction (a) of the raw film is preferably made to be in the range of −10°<φ₀≦25°.

In the present invention, the angle θ₁ formed by the in-plane slow axis (b) of a polymer film to be obtained and the transverse direction (a) of the polymer film satisfies preferably 40°≦θ₁≦50°, and more preferably 44°≦θ₁≦46°.

The angle θ₁ formed by the in-plane slow axis (b) of the polymer film and the transverse direction (a) of the polymer film can be measured by setting the transverse direction (a) of the polymer film to be 0° by using an automatic birefringence analyzer, KOBRA-21ADH (made by Oji Scientific Instruments). The sign of θ₁, in the case where the film is viewed such that the small turn side (SD) of the oblique stretching apparatus illustrated in FIG. 2 is on the left; the large turn side (LD) thereof is on the right; and the film conveyance direction is on the upper, is defined to be plus in the case where the in-plane slow axis (b) of the polymer film is present in the upper left-lower right direction, and to be minus in the case where that is present in the upper right-lower left direction (hereinafter, the sign means plus in the case where no specific sign is stated).

(Joining Methods)

As a joining method in the present invention, any of the currently-available means such as double-sided tapes, solvent fusion, thermal fusion, ultrasonic fusion and laser fusion can be used, but in the present invention, the joining is carried out preferably by ultrasonic fusion. In the case of joining using an ultrasonic vibration, the time needed for the joining is only short, and the width of the joining line of a raw film can be within 5 mm and the total thickness of the joining portion of the raw film is easily controlled within 1.5 times.

<Ultrasonic Fusion>

The ultrasonic fusion is a method in which a powerful frictional heat is caused to be generated on joining surfaces of the films to thereby melt and bond a resin by converting an electric energy to a mechanical vibration energy and simultaneously impressing a pressure. For example, films are caused to be mechanically vibrated at a vibration amplitude of 0.05 mm at a frequency of 20,000 to 28,000 times per second to generate heat, enabling instantaneous fusion.

The joining line of the joining portion of the raw film has a width within 5 mm, and preferably within 2 mm, from the viewpoint of the prevention of the generation of twitch, the joining strength and the like.

It is preferable from the viewpoint of the stress generated at the time of stretching, the prevention of the generation of twitch, and the like that raw films are fused under pressure so that the total thickness of the joining portion of raw films becomes within 1.1 to 1.5 times the average film thickness of the raw films to be joined.

It is preferable that end parts in the width direction of the joining line of the raw films are further heated so that the film thickness thereof becomes 1.3 times or less the average film thickness of the raw films. Such a way can nearly equalize the forces exerted on holding implements and the strains of the films across the joining line and the other portions, and can avoid rupture, when the raw film is stretched by holding the raw film by the holding implements (e.g., clips) in later tenter section 5.

There is a case where a resin melted at the time of fusion protrudes from end parts in the transverse direction, and since this protrusion may cause the film to be caught in later steps, and may contact and contaminate the holding implements when the stretching is carried out by holding the end portions by the holding implements in tenter section 5, the protrusion is preferably removed. Examples of a removal method include a method using a laser cutter and a method using a rotary die cutter, but cutting is carried out preferably by a laser cutter.

<Thermal Fusion>

In the thermal fusion, the joining is carried out, for example, by using a heat sealer (as illustrated in FIG. 2 of Japanese Patent Application Laid-Open No. 2009-90651). The heat sealer fuses films by means of heaters provided on vertically opposite sides of the conveyance path. The heaters are controlled in a predetermined temperature range which melts but does not decompose the films. The upper and lower heaters are brought into contact with the overlapped region of the films; thereby, parts of the films melt and adhere to thereby join the preceding raw film and the following raw film.

<Laser Fusion>

A laser fusion apparatus applies a fusion laser beam from above the raw films along the joining line. The fusion laser beam mutually melts and joins the preceding raw film and the following raw film. At this time, the laser fusion apparatus applies the fusion laser beam, with an upper surface of the preceding raw film as the focus position (a lower surface of the following raw film). The application of the fusion laser beam generates heat on the upper surface of the preceding raw film and melts the film; and the heat transfers to the lower surface of the following raw film and melts the film. Thereby, the preceding raw film and the following raw film are fused (joined) at the portion of a joining line.

<Joining by a Tape>

In the case of joining by a tape, a preferable method using a double-sided tape is a method wherein pressure-sensitive adhesive layers are provided on both surfaces of a base material exhibiting nearly the same behavior as the films in the stretching temperature range.

(Raw Film)

A raw film to be used in the present invention is mainly a thermoplastic resin. Preferable thermoplastic resins as common resins for optical films are polycarbonate, polyester, polyether sulfone, polyarylate, polyimide, polyolefin and the like. There may be used polyethylene terephthalate, polyimide, polymethyl methacrylate, polysulfone, polyethylene, polyvinyl chloride, alicyclic olefin polymers, acrylic resins, cellulose diacetate, cellulose triacetate, cellulose acetate propionate and the like. More preferable are especially cellulose diacetate, cellulose triacetate, cellulose acetate propionate, acrylic resins having a lactone ring structure and the like. These raw materials may be used singly or as a mixture with different thermoplastic resins. In the case of a mixture, a mixture of cellulose acetate and an acrylic resin is more preferable.

The raw film may suitably contain compounding agents including colorants such as pigment or dye, fluorescent brighteners, dispersants, thermostabilizers, light stabilizers, ultraviolet absorbents, antistatic agents, antioxidants, lubricants, and solvents.

The raw film may be a single layer film or a multi-layer film.

As the raw film, an unstretched polymer film is mainly used, but the raw film may be a film having already been subjected to any of longitudinal stretching, transverse stretching and oblique stretching singly or plural times.

<Cellulose Ester>

The raw film to be used in the present invention can be fabricated using various types of resin base materials, but preferably contains a cellulose ester.

The cellulose ester usable in the present invention is preferably at least one selected from cellulose (di, tri)acetate, cellulose propionate, cellulose butyrate, cellulose acetate propionate, cellulose acetate butyrate, cellulose acetate phthalate, and cellulose phthalate.

Especially preferable cellulose esters among these include cellulose triacetate, cellulose diacetate, cellulose propionate, cellulose butyrate, cellulose acetate propionate, and cellulose acetate butyrate.

As to the degree of substitution of a mixed fatty acid ester, in the case where the ester has a C₂₋₄ acyl group as a substituent, the ester is preferably a cellulose ester that satisfies the following Equations (a) and (b) simultaneously:

2.0≦Z+Y≦3.0 Equation (a)

0≦Z≦2.5 Equation (b)

where Z is the degree of substitution with acetyl group, and Y is the degree of substitution with propionyl group or butyryl group.

The cellulose ester to be used in the present invention has a ratio of weight-average molecular weight Mw to number-average molecular weight Mn of preferably 1.5 to 5.5, especially preferably 2.0 to 5.0, more preferably 2.5 to 5.0, and still more preferably 3.0 to 5.0.

A raw material cellulose of the cellulose ester to be used in the present invention may be wood pulp or cotton linter; the wood pulp may be from coniferous trees or broadleaf trees, but coniferous trees are more preferable. Cotton linter is preferably used from the viewpoint of peelability in film formation. Cellulose esters fabricated from these may be suitably used in mixtures or singly.

For example, the cellulose ester(s) can be used in a ratio of a cellulose ester originated from cotton linter:a cellulose ester originated from a wood pulp (coniferous tree):a cellulose ester originated from a wood pulp (broadleaf tree) of 100:0:0, 90:10:0, 85:15:0, 50:50:0, 20:80:0, 10:90:0, 0:100:0, 0:0:100, 80:10:10, 85:0:15 or 40:30:30.

In the present invention, the cellulose ester preferably has a pH of 6 to 7 and an electric conductivity of 1 to 100 μS/cm when 1 g of the cellulose ester is charged in 20 ml of pure water (electric conductivity: 0.1 μS/cm or lower, pH: 6.8), and stirred at 25° C. for 1 hour under a nitrogen atmosphere.

A raw film to be used in the present invention may contain the above-mentioned cellulose acetate and a thermoplastic resin other than that as long as they do not compromise the effects of the present invention. A thermoplastic resin component to be mixed is preferably one excellent in compatibility with a cellulose ester, and exhibits a transmittance, when being made into a polymer film, of preferably 80% or higher, more preferably 90% or higher, and still more preferably 92% or higher.

The thermoplastic resins usable are, as general-purpose resins, polyethylene (PE), high-density polyethylene, medium-density polyethylene, low-density polyethylene, polypropylene (PP), polyvinyl chloride (PVC), polyvinylidene chloride, polystyrene (PS), polyvinyl acetate (PVAc), Teflon® (polytetrafluoroethylene, PTFE), ABS resins (acrylonitrile-butadiene-styrene resins), AS resins, acrylate resins (PMMA), and the like.

In the case where the strength and the resistance to breakage are especially required, the thermoplastic resins usable are polyamide (PA), nylon, polyacetal (POM), polycarbonate (PC), modified polyphenylene ether (m-PPE, modified PPE, PPO), polybutylene terephthalate (PBT), polyethylene terephthalate (PET), glass fiber-reinforced polyethylene terephthalate (GF-PET), cyclic polyolefin (COP), and the like.

Further in the case where high heat distortion temperature and long-term use are required, the thermoplastic resins usable are polyphenylene sulfide (PPS), polytetrafluoroethylene (PTFE), polysulfone, polyether sulfone, amorphous polyarylate, liquid crystal polymers, polyether ether ketone, thermoplastic polyinmide (PI), polyamide-imide (PAI), and the like.

The types and molecular weights of resins can be combined according to the intended applications of the present invention.

Cellulose esters are industrially synthesized using sulfuric acid as a catalyst; however, the sulfuric acid is not completely removed and the residual sulfuric acid causes various types of decomposition reactions in the time of melt film-formation and has an influence on the quality of a cellulose ester film to be obtained; therefore, the content of residual sulfuric acid in the cellulose ester to be used in the present invention is preferably in the range of 0.1 to 40 ppm in terms of sulfur element. These are believed to be contained in a form of salts. If the content of residual sulfuric acid exceeds 40 ppm, deposits on a die lip at the time of thermal melting increase, which is not preferable. Rupture easily occurs when slitting is carried out at the time of thermal stretching or after thermal stretching, which is not preferable. Although a lower content of the residual sulfuric acid is preferable, not only the burden in a washing step of a cellulose ester becomes excessively large in order to make the content lower than 0.1, which is not preferable, but also conversely rupture easily occurs in some cases, which is not preferable. This may be because the increase in the number of washing steps has an influence on the resin, but the reason is not clear. The content of residual sulfuric acid is further preferably in the range of 0.1 to 30 ppm. The content of residual sulfuric acid can be measured similarly according to ASTM-D817-96.

The total amount of residual acids including other residual acids (e.g., acetic acid) is preferably 1,000 ppm or lower, more preferably 500 ppm or lower, and still more preferably 100 ppm or lower.

Washing of the cellulose ester can be accomplished by using, in addition to water, a poor solvent such as methanol or ethanol, or a mixed solvent of a poor solvent and a good solvent if the mixed solution is finally a poor solvent, and can remove inorganic substances other than the residual acids, and low-molecular organic impurities.

In order to improve heat resistance, mechanical properties, optical properties and the like of the cellulose ester, the cellulose ester is dissolved in a good solvent of the cellulose ester, and thereafter reprecipitated in a poor solvent to thereby enable removal of low-molecular weight components of the cellulose ester and other impurities. After reprecipitation of the cellulose ester, other polymers or low-molecular compounds may be further added thereto.

The cellulose ester to be used in the present invention is preferably one having only a few light spot-foreign substances when being made into a film. The light spot-foreign substance refers to a spot through which light of a light source can be seen when two sheets of polarizing plates are orthogonally disposed (crossed Nicol); a cellulose ester film is disposed therebetween; and light of the light source is applied on one surface of the film, and the cellulose ester film is observed from the other surface thereof. The polarizing plates to be used for evaluation at this time are desirably ones constituted of a protective film having no light spot-foreign substance, and polarizing plates using a glass plate for protection of a polarizer are preferably used. One cause of the light spot-foreign substance is believed to be a cellulose unacetified or of a low degree of acetification contained in a cellulose ester. The light spot-foreign substance may be removed by the use of a cellulose ester having only a few light spot-foreign substances, and the filtration of a melted cellulose ester or a cellulose ester solution, or by once making a solution state in at least one of a process of the later synthesis period of a cellulose ester and a process of obtaining the precipitate, and subjecting the solution to a similar filtration step. Since a melted resin has a high viscosity, the latter method is more efficient.

The raw film to be used in the present invention may further contain a polymer component other than a cellulose ester later described.

<Polymer or Oligomer>

The raw film to be used in the present invention also preferably contains a cellulose ester, and also a polymer or oligomer of a vinylic compound having a substituent selected from carboxyl group, hydroxyl group, amino group, amide group and sulfonic acid group, and having a weight-average molecular weight in the range of 500 to 200,000. The mass ratio of the cellulose ester to the polymer or oligomer is preferably in the range of 95:5 to 50:50.

Hereinafter, the polymer or oligomer to be used in the present invention will be described.

The carboxyl group is a group having the structure —COO—. The amino group is a group having the structure —NR1(R2), and R1 and R2 each represent a substituent such as a hydrogen atom, an alkyl group or a phenyl group. The amide group is a group having the structure —NHCO—, and a substituent such as an alkyl group or a phenyl group may be attached thereto.

Examples of the polymer or oligomer to be used in the present invention include the following acrylic polymers and oligomers.

These compounds are used in the range of 5 to 50% by weight to the cellulose ester, and are preferably highly compatible, and are made to have transmittances when being made into a film, over the entire visible range (400 nm to 800 nm), of 80% or higher, preferably 90% or higher, and more preferably 92% or higher.

<Acrylic Polymer and Oligomer>

The acrylic polymer and oligomer to be used in the present invention is not especially limited in the structure, but preferably is a polymer having a weight-average molecular weight, as obtained by polymerizing an ethylenically unsaturated monomer, of 500 or higher and 200,000 or lower.

The acrylic polymer and oligomer to be used in the present invention may be constituted of a single monomer, or may be constituted of plural types of monomers. The monomer is preferably selected from acrylate esters and methacrylate esters, but may suitably contain other monomers such as maleic anhydride and styrene according to the retardation property, the wavelength dispersion property and the heat resistance of a film to be fabricated.

Hereinafter, the acrylic polymer and oligomer to be used in the present invention will be designated as polymer X.

<Polymer X>

Polymer X to be used in the present invention is preferably a polymer represented by the following general formula (1) obtained by copolymerizing an ethylenically unsaturated monomer Xa having no aromatic ring and no polar group in its molecule and an ethylenically unsaturated monomer Xb having no aromatic ring and a polar group in its molecule and having a weight-average molecular weight of 500 to 200,000. Moreover, it is preferable that polymer X is a solid at 30° C. or lower, or has a glass transition temperature of 35° C. or higher.

When the weight-average molecular weight is 500 to 200,000, the compatibility of polymer X with the cellulose ester and transparency are excellent.

—[Xa]m-[Xb]n- General formula (1):

where m and n represent molar compositional ratios, and m+n==100.

Non-exclusive examples of monomers as the monomer unit constituting polymer X to be used in the present invention are given below.

Examples of the ethylenically unsaturated monomer Xa having no aromatic ring and no polar group in its molecule include methyl acrylate, ethyl acrylate, (i-, n-)propyl acrylate, (n-, i-, s-, t-)butyl acrylate, (n-, i-, s-)pentyl acrylate, (n-, i-)hexyl acrylate, (n-, i-)heptyl acrylate, (n-, i-)octyl acrylate, (n-, i-)nonyl acrylate, (n-, i-)myristyl acrylate, (2-ethylhexyl)acrylate, (ε-caprolactone) acrylate, (2-hydroxyethyl)acrylate, (2-ethoxyethyl)acrylate and those in which methacrylate esters are substituted for the above acrylate esters. Above all, preferable are methyl acrylate, ethyl acrylate, methyl methacrylate, ethyl methacrylate and (i-, n-)propyl methacrylate.

The ethylenically unsaturated monomer Xb having no aromatic ring and a polar group in its molecule is preferably an monomeric acrylate ester or methacrylate ester having a hydroxyl group, and examples thereof include hydroxyl group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and (4-hydroxymethylcyclohexyl)-methyl acrylate; carboxyl group-containing monomers such as (meth)acrylic acid, carboxyethyl (meth)acrylate, carboxypentyl (meth)acrylate, itaconic acid, maleic acid, fumaric acid and crotonic acid; acid anhydride group-containing monomers such as maleic anhydride and itaconic anhydride; a caprolactone addition product of acrylic acid; sulfonic acid group-containing monomers such as styrenesulfonic acid and allylsulfonic acids, 2-(meth)acrylamide-2-methylpropanesulfonic acid, (meth)acrylamidepropanesulfonic acid, sulfopropyl (meth)acrylate and (meth)acryloyloxynaphthalenesulfonic acid; and phosphoric acid group-containing monomers such as 2-hydroxyethylacryloyl phosphate.

There are also cited, as monomer examples for modification, (N-substituted) amide-based monomers such as (meth)acrylamide, N,N-dimethyl(meth)acrylamide, N-butyl(meth)acrylamide, N-methylol(meth)acrylamide and N-methylolpropane(meth)acrylamide; alkylaminoalkyl (meth)acrylate-based monomers such as aminoethyl (meth)acrylate, N,N-dimethylaminoethyl (meth)acrylate and t-butylaminoethyl (meth)acrylate; alkoxyalkyl (meth)acrylate-based monomers such as methoxyethyl (meth)acrylate and ethoxyethyl (meth)acrylate; and succinimide-based monomers such as N-(meth)acryloyloxymethylenesuccinimide, N-(meth)acryloyl-6-oxyhexamethylenesuccinimide. N-(meth)acryloyl-8-oxyoctamethylenesuccinimide and N-acryloylmorpholine.

Also usable are vinyl-based monomers such as vinyl acetate, vinyl propionate, N-vinyl pyrrolidone, methylvinyl pyrrolidone, vinylpyridine, vinyl piperidone, vinylpyrimidine, vinylpiperazine, vinylpyrazine, vinylpyrrole, vinylimidazole, vinyloxazol, vinylmorpholine, N-vinylcarboxylic amides, styrene, α-methylstyrene and N-vinylcaprolactam; cyanoacrylate-based monomers such as acrylonitrile and methacrylonitrile; epoxy group-containing acrylic monomers such as glycidyl (meth)acrylate; glycol-based acrylate ester monomers such as polyethylene glycol (meth)acrylate, polypropylene glycol (meth)acrylate, methoxyethylene glycol (meth)acrylate and methoxypolypropylene glycol (meth)acrylate; and acrylate ester-based monomers such as tetrahydrofurfuryl (meth)acrylate, fluorine (meth)acrylate, silicone (meth)acrylate and 2-methoxyethyl acrylate.

In the present invention, polymer X is synthesized by copolymerization using the hydrophobic monomer Xa and the polar monomer Xb. A ternary copolymer may be synthesized with the above-mentioned hydrophobic monomer or polar monomer as a monomer Xc.

The use ratio in synthesis of the hydrophobic monomer Xa and the polar monomer Xb is preferably in the range of 99:1 to 50:50, and more preferably in the range of 95:5 to 60:40. A high use ratio of the hydrophobic monomer Xa decreases the compatibility with the cellulose ester, but has a large effect of reducing fluctuations in the retardation value to the environmental humidity. A high use ratio of the polar monomer Xb makes good the compatibility with the cellulose ester, but exhibits large fluctuations in the retardation value to the environmental humidity. If the use ratio of the polar monomer Xb exceeds the above-mentioned range, haze occurs at the time of film formation, which is not preferable.

In order to synthesize such a polymer, the control of the molecular weight is difficult in typical polymerization, and a method is desirably used which does not make the molecular weight too high and can make the molecular weight as uniform as possible. Examples of such a polymerization method include a method using a peroxide polymerization initiator such as cumene peroxide or t-butyl hydroperoxide, a method using a larger amount of a polymerization initiator than usual polymerization, a method using a chain transfer agent such as a mercapto compound or a carbon tetrachloride in addition to a polymerization initiator, a method using a polymerization terminator such as benzoquinone or dinitrobenzene in addition to a polymerization initiator, and further a method as in Japanese Patent O.P.I. Publication No. 2000-128911 or 2000-344823, in which bulk polymerization is carried out using a polymerization catalyst of a compound having one thiol group and secondary hydroxyl group, or of a combination of the compound and an organometal compound; and any of the methods is preferably used in the present invention.

The weight-average molecular weight of polymer X to be used in the present invention can be adjusted by any of the well-known molecular weight adjustment methods. Examples of such a molecular weight-adjustment method include a method that involves the addition of a chain transfer agent such as carbon tetrachloride, laurylmercaptan or octyl thioglycolate. The molecular weight adjustment is typically carried out at a polymerization temperature ranging from room temperature to 130° C., and preferably 50° C. to 100° C., and can be carried out by adjustment of temperature or polymerization reaction time.

The measurement of the weight-average molecular weight can be carried out by the above-mentioned molecular weight measurement method.

The amount of polymer X to be added is suitably adjusted in order to provide a film with a desired performance. Polymer X is added in order to reduce fluctuations in the photoelastic coefficient and the retardation value to the environmental humidity; and a small amount of the addition thereof suffices in order to raise the retardation performance; but if the amount to be added is too small, in the case where the film is used as a retardation film for a liquid crystal television, there occurs corner unevenness in which the colors of the corners of a screen vary, fluctuations in the view angle, and changes in color tone due to changes in the retardation value from an initially set value at production; and if an excessive amount is added, the necessary retardation performance cannot be attained; therefore, the added amount is preferably 5% by weight or larger and 50% by weight or smaller.

<Others: Additives>

The raw film to be used in the present invention can contain various types of additives according to the intended purpose. Hereinafter, main additives will be described.

(Saccharide Ester Compounds)

Examples of polyesteric resins which can be contained in the raw film to be used in the present invention include saccharide ester compounds.

Examples of the saccharide ester compounds include ester compounds which have 1 to 12 units of at least one of a pyranose structure and a furanose structure and in which all or some of the OH groups in the structure are esterified.

The degree of esterification is preferably 70% or higher of the OH groups present in the pyranose structure or furanose structure.

Examples of saccharide ester compound as a synthesis raw material of the saccharide ester compounds include the following, but the present invention is not limited thereto.

Examples thereof include glucose, galactose, mannose, fructose, xylose, arabinose, lactose, sucrose, nystose, 1F-fructosylnystose, stachyose, maltitol, lactitol, lactulose, cellobiose, maltose, cellotriose, maltotriose, raffinose and kestose.

Additional examples thereof include genthiobiose, genthiotriose, genethiotetraose, xylotriose and galactosylsucrose.

Among the above-mentioned compounds, especially compounds having both a pyranose structure and a furanose structure are preferable. Examples of the compounds having both a pyranose structure and a furanose structure are preferably sucrose, kestose, nystose, 1F-fructosylnystose and stachyose, and more preferably sucrose.

Monocarboxylic acids to be used for esterification of all or some of the OH groups in the pyranose structure or the furanose structure are not especially limited, and usable are well-known aliphatic monocarboxylic acids, alicyclic monocarboxylic acids, aromatic monocarboxylic acids and the like. Carboxylic acids to be used may be one type or a mixture of two or more.

Preferable aliphatic monocarboxylic acids include saturated fatty acids such as acetic acid, propionic acid, butyric acid, isobutyric acid, valeric acid, caproic acid, enanthic acid, caprylic acid, pelargonic acid, capric acid, 2-ethyl-hexanecarboxylic acid, undecylic acid, lauric acid, tridecyl acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid and lacceric acid, and unsaturated fatty acids such as undecylenic acid, oleic acid, sorbic acid, linolic acid, linolenic acid, arachidonic acid and octenoic acid.

Examples of preferable alicyclic monocarboxylic acids include acetic acid, cyclopentanecarboxylic acid, cyclohexanecarboxylic acid, cyclooctanecarboxylic acid and derivatives thereof.

Examples of preferable aromatic monocarboxylic acids include benzoic acid, aromatic monocarboxylic acids in which an alkyl group or an alkoxy group is incorporated to a benzene ring of benzoic acid such as toluic acid, and aromatic monocarboxylic acids having two or more benzene rings such as cinnamic acid, benzilic acid, biphenylcarboxylic acid, naphthalenecarboxylic acid and tetralincarboxylic acid, and derivatives thereof, and more specifically include xylic acid, hemellitic acid, mesitylene acid, prehnitic acid, γ-isodurylic acid, durylic acid, mesitoic acid, α-isodurylic acid, cuminic acid, α-toluic acid, hydratropic acid, atropic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, homovanillic acid, homoveratric acid, o-homoveratric acid, phthalonic acid and p-coumaric acid, but especially benzoic acid is preferable.

As compounds having 1 to 12 units of at least one of a pyranose structural unit or a furanose structural unit, ester compounds of oligosaccharides can be applied.

The oligosaccharides are produced by making an enzyme such as amylase act on starch, cane sugar or the like, and examples include maltooligosaccharides, isomaltooligosaccharide, fractooligosaccharides, galactooligosaccharides and xylooligosaccharides.

Hereinafter, one example of saccharide ester compounds is cited, but the present invention is not limited thereto.

Monopet SB: made by Dai-ichi Kogyo Seiyaku Co., Ltd., Monopet SOA: made by Dai-ichi Kogyo Seiyaku Co., Ltd.

The amount of these saccharide ester compounds to be added is preferably 0.5 to 30% by weight, and especially preferably 5 to 20% by weight, based on the total mass of polymer X and the cellulose ester.

(Plasticizer)

The raw film to be used in the present invention can contain a plasticizer. The plasticizer is not especially limited, but is preferably selected from polyvalent carboxylate ester-based plasticizers, glycolate-based plasticizers, phthalate ester-based plasticizers, fatty acid ester-based plasticizers, polyhydric alcohol esteric plasticizers, polyesteric plasticizers, acrylic plasticizers and the like. In the case of using two or more types of plasticizers among these, at least one type is preferably a polyhydric alcohol esteric plasticizer.

The polyhydric alcohol esteric plasticizer is a plasticizer composed of an ester of a di- or more hydric aliphatic alcohol and a monocarboxylic acid, and preferably has an aromatic ring or a cycloalkyl ring in its molecule. The ester is preferably a di- to 20-hydric aliphatic alcohol ester.

The polyhydric alcohol to be preferably used in the present invention is represented by the following general formula (2).

Ra—(OH)n General formula (2):

where Ra represents an n-valent organic group; n represents a positive integer of 2 or more; and the OH group represents an alcoholic and/or phenolic hydroxyl group.

Examples of preferable polyhydric alcohols include the following, but the present invention is not limited thereto. Examples thereof include adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol. Especially preferable are triethylene glycol, tetraethylene glycol, dipropylene glycol, tripropylene glycol, sorbitol, trimethylolpropane and xylitol.

Monocarboxylic acids to be used for polyhydric alcohol esters are not especially limited, and usable are well-known aliphatic monocarboxylic acids, alicyclic monocarboxylic acids, aromatic monocarboxylic acids and the like. Use of the alicyclic monocarboxylic acids and aromatic monocarboxylic acids is preferable from the viewpoint of improvement of the moisture permeability and the retainability.

Examples of preferable monocarboxylic acids include the following, but the present invention is not limited thereto.

Preferable aliphatic monocarboxylic acids are fatty acids having a C₁₋₃₂ straight chain or side chain. The number of carbon atoms is more preferably 1 to 20, and especially preferably 1 to 10. The addition of acetic acid is preferable because the compatibility with the cellulose ester is enhanced, and mixing acetic acid and other monocarboxylic acids and using the mixture is also preferable.

Preferable aliphatic monocarboxylic acids include saturated fatty acids such as acetic acid, propionic acid, butyric acid, valeric acid, caproic acid, enanthic acid, caprylic acid, pelargonic acid, capric acid, 2-ethyl-hexanoic acid, undecylic acid, lauric acid, tridecyl acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid and lacceric acid, and unsaturated fatty acids such as undecylenic acid, oleic acid, sorbic acid, linolic acid, linolenic acid and arachidonic acid.

Examples of preferable alicyclic monocarboxylic acids include cyclopentanecarboxylic acid, cyclohexanecarboxylic acid, cyclooctanecarboxylic acid and derivatives thereof.

Examples of preferable aromatic monocarboxylic acids include benzoic acid, aromatic monocarboxylic acids in which one to three alkyl groups or alkoxy groups such as a methoxy group and an ethoxy group are incorporated to a benzene ring of benzoic acid such as toluic acid, and aromatic monocarboxylic acids having two or more benzene rings such as biphenylcarboxylic acid, naphthalenecarboxylic acid and tetralincarboxylic acid, and derivatives thereof. Especially benzoic acid is preferable.

The molecular weight of the polyhydric alcohol esters is not especially limited, but is preferably 300 to 1,500, and more preferably 350 to 750. A higher molecular weight is preferable because the polyhydric alcohol esters hardly volatilize; and a lower molecular weight is preferable from the viewpoint of the moisture permeability and the compatibility with the cellulose ester.

Carboxylic acids to be used for the polyhydric alcohol esters may be one type or a mixture of two or more. All OH groups in the polyhydric alcohol may be esterified, or some of the OH groups may remain intact.

Glycolate-based plasticizers are not especially limited, and preferable are alkylphthalyl alkyl glycolates. Examples of the alkylphthalyl alkyl glycolates include methylphthalyl methyl glycolate, ethylphthalyl ethyl glycolate, propylphthalyl propyl glycolate, butylphthalyl butyl glycolate, octylphthalyl octyl glycolate, methylphthalyl ethyl glycolate, ethylphthalyl methyl glycolate, ethylphthalyl propyl glycolate, methylphthalyl butyl glycolate, ethylphthalyl butyl glycolate, butylphthalyl methyl glycolate, butylphthalyl ethyl glycolate, propylphthalyl butyl glycolate, butylphthalyl propyl glycolate, methylphthalyl octyl glycolate, ethylphthalyl octyl glycolate, octylphthalyl methyl glycolate, and octylphthalyl ethyl glycolate.

Examples of phthalate ester-based plasticizers include diethyl phthalate, dimethoxyethyl phthalate, dimethyl phthalate, dioctyl phthalate, dibutyl phthalate, di-2-ethylhexyl phthalate, dioctyl phthalate, dicyclohexyl phthalate, and dicyclohexyl terephthalate.

Examples of citrate ester-based plasticizers include acetyl trimethyl citrate, acetyl triethyl citrate, and acetyl tributyl citrate.

Examples of fatty acid ester-based plasticizers include butyl oleate, methyl acetyl ricinoleate, and dibutyl sebacate.

Examples of phosphate ester-based plasticizers include triphenyl phosphate, tricresyl phosphate, cresyl diphenyl phosphate, octyl diphenyl phosphate, diphenyl biphenyl phosphate, trioctyl phosphate, and tributyl phosphate.

Polyvalent carboxylate ester compounds are composed of an ester of a di- or more valent, preferably di- to 20-valent carboxylic acid and an alcohol. Aliphatic polyvalent carboxylic acids preferably have di- to 20-valence, and aromatic polyvalent carboxylic acids, and alicyclic polyvalent carboxylic acids preferably have tri- to 20-valence.

Polyvalent carboxylic acids are represented by the following general formula (3).

Rb(COOH)m(OH)n General formula (3):

where Rb represents a (m+n)-valent organic group; in represents a positive integer of 2 to 6; n represents an integer of 0 to 4; the COOH group represents a carboxyl group; and the OH group represents an alcoholic or phenolic hydroxyl group.

Examples of preferable polyvalent carboxylic acids include the following, but the present invention is not limited thereto. Examples thereof preferably used are tri- or more valent aromatic carboxylic acids such as trimellitic acid, trimesic acid and pyromellitic acid, and derivatives thereof, aliphatic polyvalent carboxylic acids such as succinic acid, adipic acid, azelaic acid, sebacic acid, oxalic acid, fumaric acid, maleic acid and tetrahydrophthalic acid, and polyvalent oxycarboxylic acids such as tartaric acid, tartronic acid, malic acid and citric acid. Particularly, polyvalent oxycarboxylic acids are preferable from the viewpoint of improvement of retainability and the like.

Alcohols to be used for the polyvalent carboxylate ester compounds are not especially limited, and usable are well-known alcohols and phenols. Preferable alcohols are, for example, aliphatic saturated alcohols or aliphatic unsaturated alcohols having a C₁₋₃₂ straight chain or side chain. Having 1 to 20 carbon atoms is more preferable, and having 1 to 10 carbon atoms is especially preferable. Also preferable are alicyclic alcohols such as cyclopentanol and cyclohexanol, and derivatives thereof, and aromatic alcohols such as benzyl alcohol and cinnamyl alcohol, and derivatives thereof.

In the case of using polyvalent oxycarboxylic acids as a polyvalent carboxylic acid, alcoholic or phenolic hydroxyl groups of the polyvalent oxycarboxylic acids may be esterified using monocarboxylic acids. Examples of preferable monocarboxylic acids include the following, but the present invention is not limited thereto.

As an aliphatic monocarboxylic acid, fatty acids having a C₁₋₃₂ straight chain or side chain are preferably used. Fatty acids having 1 to 20 carbon atoms are more preferable, and those having 1 to 10 carbon atoms are especially preferable.

Examples of preferable aliphatic monocarboxylic acids include saturated fatty acids such as acetic acid, propionic acid, butyric acid, valeric acid, caproic acid, enanthic acid, caprylic acid, pelargonic acid, capric acid, 2-ethyl-hexanecarboxylic acid, undecylic acid, lauric acid, tridecyl acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid and lacceric acid, and unsaturated fatty acids such as undecylenic acid, oleic acid, sorbic acid, linolic acid, linolenic acid, and arachidonic acid.

Examples of preferable alicyclic monocarboxylic acids include cyclopentanecarboxylic acid, cyclohexanecarboxylic acid, cyclooctanecarboxylic acid, and derivatives thereof.

Examples of preferable aromatic monocarboxylic acids include benzoic acid, aromatic monocarboxylic acids in which an alkyl group is incorporated to a benzene ring of benzoic acid such as toluic acid, and aromatic monocarboxylic acids having two or more rings such as biphenylcarboxylic acid, naphthalenecarboxylic acid and tetralincarboxylic acid, and derivatives thereof.

Among these monocarboxylic acids, especially acetic acid, propionic acid and benzoic acid are preferable.

The molecular weight of the polyvalent carboxylate ester compounds is not especially limited, but is preferably in the range of 300 to 1,000, and more preferably 350 to 750. A higher molecular weight is preferable from the viewpoint of improvement of the retainability, and a lower molecular weight is preferable from the viewpoint of moisture permeability and compatibility with the cellulose ester.

Alcohols to be used for the polyvalent carboxylate esters may be one type or a mixture of two or more.

The acid value of the polyvalent carboxylate ester compounds is preferably 1 mgKOH/g or lower, and more preferably 0.2 mgKOH/g or lower. Making the acid value in the above range limits the environmental fluctuations of retardation, which is preferable.

(Acid Value)

The acid value as used herein refers to a milligram number of potassium hydroxide necessary for neutralizing an acid (carboxyl group present in a sample) contained in 1 g of the sample. The acid value is measured according to JIS K0070.

Examples of especially preferable polyvalent carboxylate ester compounds are cited below, but the present invention is not limited thereto. Examples thereof include triethyl citrate, tributyl citrate, acetyl triethyl citrate (ATEC), acetyl tributyl citrate (ATBC), benzoyl tributyl citrate, acetyl triphenyl citrate, acetyl tribenzyl citrate, dibutyl tartrate, diacetyl dibutyl tartrate, tributyl trimellitate and tetrabutyl pyromellitate.

Polyesteric plasticizers are not especially limited, but usable are polyesteric plasticizers having an aromatic ring or a cycloalkyl ring in their molecule. Polyesteric plasticizers are not especially limited, but usable are, for example, aromatic-terminated esteric plasticizers represented by the following general formula (4).

B—COO-((G-O-)m-CO-A-COO-)nG-O—CO—B General formula (4):

wherein B represents a benzene ring which may have a substituent; G represents a C₂₋₁₂ alkylene group, a C₆₋₁₂ arylene group or a C₄₋₁₂ oxyalkylene group; A represents a C₂₋₁₀ alkylene group or a C₄₋₁₀ arylene group; and m and n represent numbers of repeating units.

The compounds of the general formula (4) are synthesized from a benzenemonocarboxylic acid group represented by BCOOH, an alkylene glycol group, an oxyalkylene glycol group or an aryl glycol group represented by HO-(G-O-)m-H, and an alkylenedicarboxylic acid group or an aryldicarboxylic acid group represented by HOCO-A-COO—H, and are obtained by similar reactions to those for typical polyesteric plasticizers.

Examples of benzenemonocarboxylic acid components as a raw material of the polyesteric plasticizer include benzoic acid, para-tertiary-butylbenzoic acid, ortho-toluic acid, meta-toluic acid, para-toluic acid, dimethylbenzoic acid, ethylbenzoic acid, normal-propylbenzoic acid, aminobenzoic acid and acetoxybenzoic acid, and these can be used singly or as a mixture of two or more.

Examples of alkylene glycol components as a raw material of the polyesteric plasticizer include ethylene glycol, 1,2-propylene glycol, 1,3-propylene glycol, 1,2-butanediol, 1,3-butanediol, 1,2-propanediol, 2-methyl-1,3-propanediol, 1,4-butanediol, 1,5-pentanediol, 2,2-dimethyl-1,3-propanediol (neopentyl glycol), 2,2-diethyl-1,3-propanediol(3,3-dimethylolpentane), 2-n-butyl-2-ethyl-1,3-propanediol(3,3-dimethylolheptane), 3-methyl-1,5-pentanediol-1,6-hexanediol, 2,2,4-trimethyl-1,3-pentanediol, 2-ethyl-1,3-hexanediol, 2-methyl-1,8-octanediol, 1,9-nonanediol, 1,10-decanediol, and 1,12-octadecanediol, and these glycols are used singly or as a mixture of two or more. Especially C₂₋₁₂ alkylene glycols are preferable because of being excellent in the compatibility with the cellulose ester.

Examples of C₄₋₁₂ oxyalkylene glycol components as a raw material of the aromatic-terminated esters include diethylene glycol, triethylene glycol, tetraethylene glycol, dipropylene glycol, and tripropylene glycol, and these glycols can be used singly or as a mixture of two or more.

Examples of C₄₋₁₂ alkylenedicarboxylic acid components as a raw material of the aromatic-terminated esters include succinic acid, maleic acid, fumaric acid, glutaric acid, adipic acid, azelaic acid, sebacic acid, and dodecanedicarboxylic acid, and these are used singly or as a mixture of two or more. Examples of C₆₋₁₂ arylenedicarboxylic acid components include phthalic acid, terephthalic acid, isophthalic acid, 1,5-naphthalenedicarboxylic acid, and 1,4-naphthalenedicarboxylic acid.

The number-average molecular weight of the polyesteric plasticizers is preferably in the range of 300 to 1,500, and more preferably 400 to 1,000. The acid value is 0.5 mgKOH/g or lower, and the hydroxyl value is 25 mgKOH/g or lower, and more preferably, the acid value is 0.3 mgKOH/g or lower, and the hydroxyl value is 15 mgKOH/g or lower.

(Ultraviolet Absorbent)

The raw film to be used in the present invention may also contain an ultraviolet absorbent. The ultraviolet absorbent is added to absorb ultraviolet rays of 400 nm or shorter to thereby improve the durability; the transmittance particularly at a wavelength of 370 nm is preferably 10% or lower, more preferably 5% or lower, and still more preferably 2% or lower.

The ultraviolet absorbent is not especially limited, but examples include oxybenzophenone-based compounds, benzotriazol-based compounds, salicylate ester-based compounds, benzophenone-based compounds, cyanoacrylate-based compounds, triazine-based compounds, nickel complex salt-based compounds, and inorganic powders.

Examples thereof include 5-chloro-2-(3,5-di-sec-butyl-2-hydroxyphenyl)-2H-benzotriazol, (2-2H-benzotriazol-2-yl)-6-(straight chain and side chain dodecyl)-4-methyl phenol, 2-hydroxy-4-benzyloxybenzophenone, and 2,4-benzyloxybenzophenone, and preferable are Tinuvins such as Tinuvin 109, Tinuvin 171, Tinuvin 234, Tinuvin 326. Tinuvin 327, Tinuvin 328, and Tinuvin 928, which are all commercially available products made by BASF Japan Ltd.

The ultraviolet absorbents preferably used in the present invention are benzotriazol-based ultraviolet absorbents, benzophenone-based ultraviolet absorbents and triazine-based ultraviolet absorbents, and especially preferable are benzotriazol-based ultraviolet absorbents, and benzophenone-based ultraviolet absorbents.

In addition, disc-like compounds such as compounds having a 1,3,5-triazine ring are advantageously used as an ultraviolet absorbent.

The addition method of the ultraviolet absorbent may involve dissolving the ultraviolet absorbent in an organic solvent such as an alcohol such as methanol, ethanol or butanol, or methylene chloride, methyl acetate, acetone or dioxolane, or a mixed solvent thereof, and then adding the solution to a dope, or directly adding the ultraviolet absorbent to a dope composition.

Substances which are undissolvable in organic solvents like inorganic powders are dispersed in an organic solvent and a polymer by using a dissolver or a sand mill, and then added to a dope.

In the case where an optical film has a dried film thickness of 30 to 200 μm, the amount of an ultraviolet absorbent to be used, though depending on the type, the usage condition and the like of the ultraviolet absorbent, is preferably 0.5 to 10% by weight, and more preferably 0.6 to 4% by weight, based on a polymer.

(Antioxidant)

The raw film to be used in the present invention can contain an antioxidant. The antioxidant is called also a deterioration preventive agent. In the case where liquid crystal image displays or the like are placed in a high-humidity high temperature condition, optical films are caused to deteriorate in some cases.

Since antioxidants have functions of, for example, retarding and preventing the decomposition of optical films due to halogens in a residual solvent, phosphorus of a phosphoric acid-based plasticizer, and the like in the optical films, the antioxidants are preferably contained in the optical films.

As such an antioxidant, hindered phenol-based compounds are preferably used, and examples include 2,6-di-t-butyl-p-cresol, pentaerythrityl-tetrakis[3-(3,5-di-t-butyl-4-hydroxyphenyl)propionate], triethylene glycol-bis[3-(3-t-butyl-5-methyl-4-hydroxyphenyl)propionate], 1,6-hexanediol-bis[3-(3,5-di-t-butyl-4-hydroxyphenyl)propionate], 2,4-bis-(n-octylthio)-6-(4-hydroxy-3,5-di-t-butylanilino)-1,3,5-triazine, 2,2-thio-diethylenebis[3-(3,5-di-t-butyl-4-hydroxyphenyl)propionate], octadecyl-3-(3,5-di-t-butyl-4-hydroxyphenyl)propionate, N,N′-hexamethylenebis(3,5-di-t-butyl-4-hydroxy-hydrocinnamide), 1,3,5-trimethyl-2,4,6-tris(3,5-di-t-butyl-4-hydroxybenzyl)benzene and tris-(3,5-di-t-butyl-4-hydroxybenzyl)-isocyanurate.

Especially preferable are 2,6-di-t-butyl-p-cresol, pentaerythrityl-tetrakis[3-(3,5-di-t-butyl-4-hydroxyphenyl)propionate] and triethylene glycol-bis[3-(3-t-butyl-5-methyl-4-hydroxyphenyl)propionate]. A hydrazine-based metal deactivator such as N,N′-bis[3-(3,5-di-t-butyl-4-hydroxyphenyl)propionyl]hydrazine and a phosphorus-based processing stabilizer such as tris(2,4-di-t-butylphenyl)phosphite may be used concurrently.

The amount of these compounds to be added is preferably 1 ppm to 1.0%, and more preferably 10 to 1,000 ppm in mass proportion, based on the total mass of polymer X and the cellulose ester.

(Microparticle)

The raw film to be used in the present invention can contain a microparticle added thereto.

Examples of inorganic compounds as the microparticle include silicon dioxide, titanium dioxide, aluminum oxide, zirconium oxide, calcium carbonate, calcium carbonate, talc, clay, calcined kaolin, calcined calcium silicate, calcium silicate hydrate, aluminum silicate, magnesium silicate and calcium phosphate. Microparticles of organic compounds can also be preferably used. Examples of organic compounds include polytetrafluoroethylene, cellulose acetate, polystyrene, polymethyl methacrylate, polypropyl methacrylate, polymethyl acrylate, polyethylene carbonate, acrylic styrenic resins, silicone-based resins, polycarbonate resins, benzoguanamine-based resins, melamine-based resins, polyolefinic powders, polyesteric resins, polyamide-based resins and polyimide-based resins, and also include crushed and classified substances of organic polymer compounds such as polyethylene fluoride-based resins and starch. Also usable are polymer compounds synthesized by the suspension polymerization method, polymer compounds made into a spherical shape by the spray dry method, the dispersion method or the like, and inorganic compounds.

The microparticle is preferably one containing silicon from the viewpoint of the turbidity being lowered, and especially silicon dioxide is preferable.

The average particle diameter of the primary particle of the microparticle is preferably 5 to 400 nm, and more preferably 10 to 300 nm. The microparticle may be contained mainly as a secondary aggregate having a particle diameter of 0.05 to 0.3 μm, and if the microparticle is a particle having an average particle diameter of 100 to 400 nm, the microparticle may be contained as a primary particle not having been aggregated.

The content of the microparticle in a polymer is preferably 0.01 to 1% by weight, and especially preferably 0.05 to 0.5% by weight.

Microparticles of silicon dioxide are commercially available for example under the trade names Aerosil R972, R972V, R974, R812, 200, 200V, 300, R202, OX50 and TT600 (which are all made by Nippon Aerosil Co., Ltd.), and are usable.

Microparticles of zirconium oxide are commercially available for example under the trade names Aerosil R976 and R811 (which are all made by Nippon Aerosil Co., Ltd.), and are usable.

Examples of resins of polymer microparticles include silicone resins, fluororesins and acrylic resins. Silicone resins are preferable, and especially those having three-dimensional network structure are preferable, which are commercially available for example under the trade names Tospearl 103, 105, 108, 120, 145, 3120 and 240 (all made by GE Toshiba Silicones Co., Ltd.), and are usable.

Among the foregoing microparticles, Aerosil 200V and Aerosil R972V are especially preferably used because of having a large effect of decreasing the friction coefficient while maintaining the turbidity of an optical film at a low level. In the optical film, the dynamic friction coefficient of at least one surface thereof is preferably 0.2 to 1.0.

Various types of additives may be batchwise added to a dope or resin-containing solution before film formation, or an additive-dissolved liquid is separately prepared, and may be in-line-wise added. Especially in order to reduce the burden to a filter material by the microparticle, part or the whole of the amount of the microparticle is preferably in-line-wise added.

In the case where an additive-dissolved liquid is in-line-wise added, in order to make good the miscibility with a dope, a small amount of a resin is preferably dissolved. The amount of the resin is preferably 1 to 10 parts by mass, and more preferably 3 to 5 parts by mass, based on 100 parts by mass of a solvent.

In the present invention, in order to carry out in-line addition and mixing, an in-line mixer such as a static mixer (made by Toray Engineering Co., Ltd.) or SWJ (Toray static in-tube mixer Hi-Mixer), or the like is preferably used.

<Acrylic Polymer>

The raw film to be used in the present invention may contains an acrylic polymer. The acrylic polymer is not especially limited as long as being a resin obtained by polymerizing a monomer composition containing a (meth)acrylate ester as the constituent. The acrylic polymer may contain two or more types of acrylic polymers as the main components.

The raw film to be used in the present invention preferably contains also a polymer having a lactone ring structure described later as an acrylic polymer.

The (meth)acrylate ester usable is, for example, a compound (monomer) having a structure represented by the general formula (5).

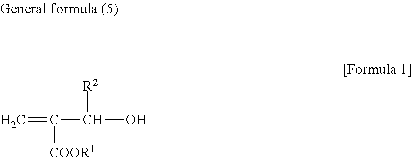

wherein R¹ and R² each independently represent a hydrogen atom or a C₁₋₂₀ organic residue.

Examples of the (meth)acrylate esters include acrylate esters such as methyl acrylate, ethyl acrylate, n-butyl acrylate, isobutyl acrylate, t-butyl acrylate, cyclohexyl acrylate, and benzyl acrylate; and methacrylate esters such as methyl methacrylate, ethyl methacrylate, propyl methacrylate, n-butyl methacrylate, isobutyl methacrylate, t-butyl methacrylate, cyclohexyl methacrylate, and benzyl methacrylate. These may be used singly or in combinations of two or more. Above all, especially methyl methacrylate is preferable from the viewpoint of being excellent in the heat resistance and the transparency. Benzyl (meth)acrylate is preferable from the viewpoint of enlarging a positive birefringence (positive retardation).

In the case where a benzyl (meth)acrylate monomer structural unit is incorporated, the content of the benzyl (meth)acrylate monomer structural unit in the acrylic polymer is preferably 5 to 50% by weight, more preferably 10 to 40% by weight, and still more preferably 15 to 30% by weight.

Examples of compounds having a structure represented by the general formula (5) include methyl 2-(hydroxymethyl)acrylate, ethyl 2-(hydroxymethyl)acrylate, isopropyl 2-(hydroxymethyl)acrylate, normal-butyl 2-(hydroxymethyl)acrylate, and tertiary-butyl 2-(hydroxymethyl)acrylate. Above all, methyl 2-(hydroxymethyl)acrylate and ethyl 2-(hydroxymethyl)acrylate are preferable, and methyl 2-(hydroxymethyl)acrylate is especially preferable from the viewpoint of having a large effect of improving heat resistance. The compounds represented by the general formula (5) may be used singly or in combinations of two or more.

The acrylic polymer may have a structure other than the structure obtained by polymerizing a (meth)acrylate ester as described above. The structure other than the structure obtained by polymerizing a (meth)acrylate ester is not especially limited, but is preferably a polymer structural unit (repeating structural unit) constructed by polymerizing at least one monomer selected from hydroxyl group-containing monomers, unsaturated carboxylic acids and monomers represented by the following general formula (6).

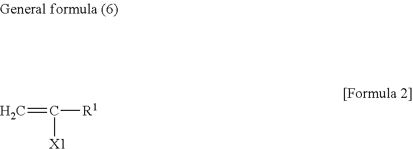

wherein R¹ represents a hydrogen atom or a methyl group; X¹ represents a hydrogen atom, a C₁₋₂₀ alkyl group, an aryl group, an —OAc group, a—CN group, a —CO—R² group or a C—O—R³ group; the Ac group represents an acetyl group; and R² and R³ each represent a hydrogen atom or a C₁₋₂₀ organic residue.

The hydroxyl group-containing monomer is not especially limited as long as being a hydroxyl group-containing monomer other than the monomer represented by the general formula (5), but examples include allyl alcohols such as methallyl alcohol, allyl alcohol, and 2-hydroxymethyl-1-butene; 2-(hydroxyalkyl)acrylate esters such as α-hydroxymethylstyrene, α-hydroxyethylstyrene, and methyl 2-(hydroxyethyl)acrylate; and 2-(hydroxyalkyl)acrylic acids such as 2-(hydroxyethyl)acrylic acid, and these may be used singly or in combinations of two or more.

Examples of the unsaturated carboxylic acid include acrylic acid, methacrylic acid, crotonic acid, α-substituted acrylic acid, and α-substituted methacrylic acid, and these may be used singly or in combinations of two or more. Above all, especially acrylic acid and methacrylic acid are preferable from the viewpoint of sufficiently exhibiting the advantage of the present invention.

Examples of the compounds represented by the general formula (6) include styrene, vinyltoluene, α-methylstyrene, acrylonitrile, methyl vinyl ketone, ethylene, propylene, and vinyl acetate, and these may be used singly or in combinations of two or more. Above all, especially styrene and α-methylstyrene are preferable from the viewpoint of sufficiently exhibiting the effects of the present invention.

A polymerization method is not especially limited, and well-known polymerization methods can be used. It suffices if a suitable method is employed according to the type, the use ratio and the like of monomers (monomer composition) to be used.

The acrylic polymer to be used in the present invention has a glass transition temperature (Tg) of preferably 110° C. to 200° C., more preferably 115° C. to 200° C., still more preferably 120° C. to 200° C., especially preferably 125° C. to 190° C., and most preferably 130° C. to 180° C.

From the viewpoint of enhancing the heat resistance, the acrylic polymer may be copolymerized with an N-substituted maleimide such as phenylmaleimide, cyclohexylmaleimide or a methylmaleimide, and a lactone ring structure, a glutaric anhydride structure, a glutarimide structure or the like may be incorporated in the molecular chain (also referred to as in the main skeleton of a polymer, or in the main chain). Above all, monomers containing no nitrogen atom is preferable from the viewpoint of resistance to coloring (yellowing) of a film, and acrylic polymers having a lactone ring structure in their main chain are preferable from the viewpoint of easily developing a positive birefringence (positive retardation).

The lactone ring structure in the main chain may have a 4- to 8-membered ring, but from the viewpoint of the stability of the structure, the structure has more preferably a 5- or 6-membered ring, and still more preferably a 6-membered ring. In the case where the lactone ring structure in the main chain has a 6-membered ring, examples of the structure include a structure represented by the general formula (7) and a structure described in Japanese Patent O.P.I. Publication No. 2004-168882, but the structure represented by the general formula (7) is preferable from the viewpoints of a high polymerization yield in synthesis of a polymer before the introduction of a lactone ring structure in the main chain, the ease of obtaining a polymer having a high content proportion of the lactone ring structure with a high polymerization yield, and the better copolymerizability with a (meth)acrylate ester such as methyl (meth)acrylate.

In the case where the acrylic polymer is a resin obtained by polymerizing a monomer containing a compound having a structure represented by the above general formula (5), the acrylic polymer more preferably has a lactone structure (hereinafter, an acrylic polymer having a lactone ring structure is described as a “lactone ring-containing polymer”). Hereinafter, the lactone ring-containing polymer will be described.

Examples of the lactone ring structure include a structure represented by the following general formula (7).

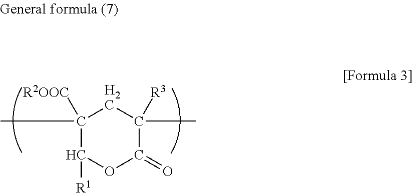

where R¹, R² and R³ each independently represent a hydrogen atom or a C₁₋₂₀ organic residue; and the organic residue may contain an oxygen atom.)

The organic residue in the above general formula (7) is not especially limited as long as the number of carbon atoms is in the range of 1 to 20, but examples include a straight-chain or branched-chain alkyl group, a straight-chain or branched-chain alkylene group, an aryl group, an —OAc group and a —CN group.

The content proportion of the lactone ring structure in the acrylic polymer is preferably in the range of 5 to 90% by weight, more preferably in the range of 20 to 90% by weight, and still more preferably in the range of 30 to 90% by weight, further still more preferably in the range of 35 to 90% by weight, especially preferably in the range of 40 to 80% by weight, and most preferably in the range of 45 to 75% by weight. If the content proportion of the lactone ring structure is higher than 90% by weight, the fabricability becomes poor. Also the flexibility of an obtained film is likely to decrease, which is not preferable. If the content proportion of the lactone ring structure is lower than 5% by weight, a film formed hardly has a necessary retardation, and exhibits insufficient heat resistance, solvent resistance and surface hardness, which are not preferable.

In the lactone ring-containing polymer, the content proportion of structures other than the lactone ring structure represented by the general formula (7), in the case of a polymer structural unit (repeating structural unit) constructed by polymerizing a (meth)acrylate ester, is preferably in the range of 10 to 95% by weight, more preferably in the range of 10 to 80% by weight, still more preferably in the range of 10 to 65% by weight, especially preferably in the range of 20 to 60% by weight, and most preferably in the range of 25 to 55% by weight. In the case of a polymer structural unit (repeating structural unit) constructed by polymerizing a hydroxyl group-containing monomer, the content proportion is preferably in the range of 0 to 30% by weight, more preferably in the range of 0 to 20% by weight, still more preferably in the range of 0 to 15% by weight, and especially preferably in the range of 0 to 10% by weight. In the case of a polymer structural unit (repeating structural unit) constructed by polymerizing an unsaturated carboxylic acid, the content proportion is preferably in the range of 0 to 30% by weight, more preferably in the range of 0 to 20% by weight, still more preferably in the range of 0 to 15% by weight, and especially preferably in the range of 0 to 10% by weight.

A production method of a lactone ring-containing polymer is not especially limited, but preferably involves obtaining a polymer having a hydroxyl group and an ester group in the molecular chain by a polymerization step, and thereafter subjecting the obtained polymer to a lactone cyclization condensation step in which the polymer is heat-treated to introduce a lactone ring structure to the polymer, to thereby obtain the lactone ring-containing polymer.

<Alicyclic Polyolefin Resin>

The raw film to be used in the present invention may contain an alicyclic polyolefin resin.

The alicyclic polyolefin resin is a noncrystalline resin having an alicyclic structure in the main and/or side chain. Examples of the alicyclic structure in the alicyclic polyolefin resin include a saturated alicyclic hydrocarbon (cycloalkane) structure and an unsaturated alicyclic hydrocarbon (cycloalkene) structure, but the alicyclic structure is preferably a cycloalkane structure from the viewpoint of the mechanical strength, the heat resistance and the like. The number of carbon atoms constituting the alicyclic structure is not especially limited, but is usually 4 to 30, preferably 5 to 20, and more preferably 5 to 15, giving highly balanced properties of mechanical strength, heat resistance and film formability, which is favorable. The proportion of a repeating unit having the alicyclic structure constituting the alicyclic polyolefin resin is preferably 55% by weight or higher, more preferably 70% by weight or higher, and especially preferably 90% by weight or higher. That the proportion of the repeating unit having the alicyclic structure in the alicyclic polyolefin resin is in this range is preferable from the viewpoint of transparency and heat resistance.

Examples of the alicyclic polyolefin resin include norbornene-based resins, monocyclic olefinic resins, cyclic conjugated dienic resins, vinyl alicyclic hydrocarbon-based resins and hydrogenated substances thereof. Above all, norbornene-based resins can advantageously be used because of having good transparency and formability.

Examples of the norbornene-based resins include a ring-opened polymers of monomers having a norbornene structure, ring-opened copolymers of monomers having a norbornene structure and other monomer(s), and hydrogenated products thereof; and addition polymers of monomers having a norbornene structure, addition copolymers of monomers having a norbornene structure and other monomer(s), and hydrogenated products thereof. Above all, the hydrogenated ring-opened (co)polymers of monomers having a norbornene structure can especially advantageously be used from the viewpoint of transparency, formability, heat resistance, low-moisture absorption, dimensional stability, light weight, and the like.

Examples of the monomers having a norbornene structure include bicyclo[2.2.1]hepto-2-ene (trivial name: norbornene), tricyclo[4.3.0.12,5]dec-3,7-diene (trivial name: dicyclopentadiene), 7,8-benzotricyclo[4.3.0.12,5]dec-3-ene (trivial name: methanotetrahydroflulorene), tetracyclo[4.4.0.12,5.17,10]dodec-3-ene (trivial name: tetracyclododecene) and derivatives thereof (e.g., monomers whose ring has a substituent). Examples of the substituent include alkyl group, alkylene group, and polar group. These substituents may be identical or different, and a plurality of the substituents may be bound to the ring. The monomers having a norbornene structure can be used singly or in combinations of two or more.

Examples of the polar group include heteroatoms or atom groups having a heteroatom. Examples of the heteroatom include oxygen, nitrogen, sulfur, silicon, and halogens. Specific examples of the polar group include carboxyl group, carbonyloxycarbonyl group, epoxy group, hydroxyl group, oxy group, ester group, silanol group, silyl group, amino group, nitrile group, and sulfone group. In order to obtain a film having a low saturated water absorption rate, smaller amounts of the polar group are preferable, and no polar groups are more preferable.

Examples of the other monomers that are ring-opening copolymerizable with the monomers having a norbornene structure include monocyclic olefins such as cyclohexene, cycloheptene and cyclooctene, and derivatives thereof; and cyclic conjugated dienes such as cyclohexadiene and cycloheptadiene, and derivatives thereof.

The ring-opened polymers of the monomers having a norbornene structure, and the ring-opened copolymers of monomers having a norbornene structure and other monomers copolymerizable therewith can be obtained by (co)polymerizing the monomers in the presence of a well-known ring-opening polymerization catalyst.

Examples of the other monomers that are addition copolymerizable with the monomers having a norbornene structure include C₂₋₂₀ α-olefins such as ethylene, propylene and 1-butene, and derivatives thereof; cycloolefins such as cyclobutene, cyclopentene and cyclohexene, and derivatives thereof; and non-conjugated dienes such as 1,4-hexadiene, 4-methyl-1,4-hexadiene and 5-methyl-1,4-hexadiene. These monomers can be used singly or in combinations of two or more. Above all, α-olefins are preferable, and ethylene is more preferable.

The addition polymers of the monomers having a norbornene structure and the addition copolymer of a monomer having a norbornene structure with another monomer copolymerizable therewith can be obtained by polymerizing the monomer(s) in the presence of a well-known addition polymerization catalyst.

The hydrogenated ring-opened polymers of the monomers having a norbornene structure; the hydrogenated ring-opened copolymers of the monomer having a norbornene structure with the other monomer(s) that are ring-opening copolymerizable therewith; the hydrogenated addition polymers of the monomers having a norbornene structure; and the hydrogenated addition copolymers of the monomers having a norbornene structure with the other monomers that are addition copolymerizable therewith can be obtained by adding a well-known hydrogenation catalyst containing a transition metal such as nickel or palladium into solutions of the ring-opened (co)polymers or addition (co)polymers, and bringing the resultant solutions into contact with hydrogen to thereby hydrogenate preferably 90% or more of the carbon-carbon unsaturated bonds.

Among the norbornene-based resins, norbornene-based resins are preferable which have, as repeating units, A: bicyclo[3.3.0]octane-2,4-diyl-ethylene structure and B: tricyclo[4.3.0.12,5]decane-7,9-diyl-ethylene structure, and in which the content of these repeating units is 90% by weight or higher based on the entire of the repeating units of the norbornene-based resins, and the ratio of the content proportion of A and the content proportion of B is preferably 100:0 to 40:60 in mass ratio of A:B. Use of such a resin can provide an optical film exhibiting no dimensional change over a long period and being excellent in the stability of optical properties.

The molecular weight of the alicyclic polyolefin resin to be favorably used in the present invention is suitably selected according to the usage purpose; but the weight-average molecular weight (Mw) thereof in terms of a polyisoprene (in terms of polystyrene in the case where a solvent is toluene) as measured by gel permeation chromatography using cyclohexane as solvent (toluene is used when the resin does not dissolve in cyclohexane) is usually 15,000 to 50,000, preferably 18,000 to 45,000, and more preferably 20,000 to 40,000. When the weight-average molecular weight is in these ranges, the mechanical strength and the formability of a film are highly balanced, which is favorable.

The molecular weight distribution (i.e. ratio of weight-average molecular weight (Mw) to number-average molecular weight (Mn)) of the alicyclic polyolefin resin to be advantageously used in the present invention is not especially limited, but is usually in the range of 1.0 to 10.0, preferably 1.1 to 4.0, and more preferably 1.2 to 3.5.

<Production Example of Raw Film>

The raw film to be used in the present invention may be produced by either the solution casting method or melt casting method. Hereinafter, as a typical example, production of a cellulose ester film by the solution casting method will be described.

Production of a cellulose ester film includes the steps of: dissolving a cellulose ester and additives such as the plasticizer in a solvent to prepare a dope, a step of casting the dope on a belt-shape or drum-shape metal support; drying the cast dope as a web; peeling the web off the metal support; stretching the web; further drying the web and, as required, subjecting the obtained film to a heat treatment; and taking up the film after cooled. The cellulose ester film to be used in the present invention preferably contains 60 to 95% by weight of a cellulose ester in the solid content.

The step of preparing a dope will be described. A higher concentration of a cellulose ester in a dope is preferable because the drying load after the dope is cast on the metal support can be reduced; but, a too high concentration of the cellulose ester increases the load in filtration, and worsens the filtration accuracy. A concentration thereof at which both conditions are satisfied is preferably 10 to 35% by weight, and more preferably 15 to 25% by weight.

Examples of an organic solvent which dissolves a cellulose ester and is useful for formation of a cellulose ester solution, or the formation of a dope include chlorine-based organic solvents and non-chlorine-based organic solvents. Examples of the chlorine-based organic solvents include methylene chloride, which is suitable for dissolution of cellulose esters, particularly cellulose triacetate. The use of non-chlorine-based organic solvents has been studied because of today's environmental problems. Examples of the non-chlorine-based organic solvents include methyl acetate, ethyl acetate, amyl acetate, acetone, tetrahydrofuran, 1,3-dioxolane, 1,4-dioxane, cyclohexanone, ethyl formate, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol and nitroethane. In the case where these organic solvents are used for cellulose triacetate, although the dissolution method at normal temperature can be used, a high-temperature dissolution method, a cooled dissolution method, a high-pressure dissolution method or the like is preferably used because of being able to reduce undissolved substances. For cellulose esters other than cellulose triacetate, although methylene chloride can be used, methyl acetate, ethyl acetate or acetone is preferably used. Especially methyl acetate is preferable. In the present invention, an organic solvent having a solubility good to the cellulose ester is called a good solvent, and an organic solvent which exhibits a main effect on the dissolution and is used in a large amount is called a main (organic) solvent.

A dope to be used in the present invention preferably contains 1 to 40% by weight of C₁₋₄ alcohols in addition to the organic solvent. After the dope is cast on a metal support, the solvent starts to evaporate and the ratio of the alcohols becomes high to thereby gel the dope film (web), make the web firm, and make it easy for the web to be peeled off the metal support; thus, the alcohols are used as a gel solvent, and when the proportion of the alcohols is small, the alcohols have also a function of promoting dissolution of a cellulose ester in a non-chlorine-based organic solvent. Examples of the C₁₋₄ alcohols include methanol, ethanol, n-propanol, iso-propanol, n-butanol, sec-butanol and tert-butanol. Above all, ethanol is preferable because of giving excellent stability to a dope, being relatively low in boiling point, and being good in drying property. Since these organic solvents have singly no solubility to a cellulose ester, these organic solvents are called poor solvents.

Adjusting the concentration of a cellulose ester in a dope at 15 to 30% by weight and the dope viscosity at 100 to 500 Pa·s is preferable for acquiring a good film surface quality.

As a method for dissolving the cellulose ester when the dope described above is prepared, a usual method can be used. If heating and pressurization are combined, the heating can be carried out at a temperature equal to or higher than the boiling point at normal pressure. If stirring and dissolution is carried out under heating at a temperature equal to or higher than the boiling point of the solvent at normal pressure and in a temperature range in which the solvent does not boil under pressure, the generation of agglomerated undissolved substances called gels and undissolved lumps is prevented, which is preferable. Also a method is preferably used in which a cellulose ester is mixed with a poor solvent and moistened or swollen, and thereafter a good solvent is further added to thereby dissolve the cellulose ester.

The pressurization may be carried out by a method forcing in an inert gas such as nitrogen gas, or a method raising the vapor pressure of the solvent by heating. The heating is carried out preferably from the outside, and for example, a jacket type apparatus is easily controlled in the temperature, which is preferable.

A higher heating temperature with a solvent being added is preferable from the viewpoint of the solubility of the cellulose ester, but a too high heating temperature makes a necessary pressure high and worsens the productivity. The heating temperature is preferably 45 to 120° C., more preferably 60 to 110° C., and still more preferably 70° C. to 105° C. The pressure is adjusted so that the solvent does not boil at a set temperature.

Alternatively, a cooled dissolution method is preferably used, and can dissolve a cellulose ester in a solvent such as methyl acetate.

The cellulose ester solution is then filtered using a proper filter material such as filter paper. A lower absolute filtration accuracy of the filter material is preferable in order to remove undissolved substances, but a too low absolute filtration accuracy poses a problem of easily generating clogging of the filter material. Therefore, the filter medium has an absolute filtration accuracy of preferably 0.008 mm or lower, more preferably 0.001 to 0.008 mm, and still more preferably 0.003 to 0.006 mm.

The material of the filter medium is not especially limited, and usable are usual filter media, but plastic filter media made of plastic such as polypropylene or Teflon®, and metal filter media made of metal such as stainless steel are preferable because there occurs no falling or the like of fibers. It is preferable that impurities, particularly light spot-foreign substances, contained in the cellulose ester as a raw material are removed or reduced by filtration.

The filtration of the dope can be carried out by a usual method, but a method, in which the filtration is carried out under heating at a temperature equal to or higher than the boiling point of the solvent at normal pressure and in a temperature range in which the solvent does not boil under pressure, is preferable because a rise in the difference in filtration pressure (called differential pressure) before and after the filtration is low. The temperature is preferably 45 to 120° C., more preferably 45 to 70° C., and still more preferably 45 to 55° C.

A lower filtration pressure is preferable. The filtration pressure is preferably 1.6 MPa or lower, more preferably 1.2 MPa or lower, and still more preferably 1.0 MPa or lower.

Here, the casting of the dope will be described.

The metal support in the casting step is preferably one whose surface has been mirror-finished; and the metal support to be preferably used is a stainless steel belt, or a drum whose surface has been plate-finished with a casting. The width of casting can be made to be 1 to 4 m. The surface temperature of the metal support in the casting step is set to −50° C. to a temperature equal to or lower than the temperature at which the solvent does not boil nor bubble. A higher temperature can make the drying speed of the web fast, which is preferable, but a too high temperature causes the web to bubble and the flatness degrades in some cases. A preferable temperature of the support is suitably decided at 0 to 100° C., and a more preferable temperature is 5 to 30° C. Alternatively, a method is also preferable in which the web is gelled by being cooled, and is peeled off the drum in the state of containing a large amount of residual solvents. A method of controlling the temperature of the metal support is not especially limited, but examples include a method of blowing warm air or cold air, and a method bringing warm water into contact with the back side of the metal support. The method using warm water is preferable because the heat is efficiently transferred and the time until the temperature of the metal support becomes constant is made short. In the case of using warm air, in consideration of a decrease in the temperature of the web due to the evaporation latent heat of the solvent, there is a case of using the warm air of a temperature equal to or higher than the boiling point of the solvent and of the temperature higher than a target temperature under prevention of bubbling. Particularly, the temperature of the support and the temperature of the drying air are preferably changed during a period from the casting to the peeling to thereby carry out drying efficiently.

In order for the cellulose ester film to exhibit good flatness, the amount of residual solvents when the web is peeled off the metal support is preferably 10 to 150% by weight, more preferably 20 to 40% by weight or 60 to 130% by weight, and especially preferably 20 to 30% by weight or 70 to 120% by weight. The temperature at a peeling position on the metal support is made to be preferably −50 to 40° C., more preferably 10 to 40° C., and most preferably 15 to 30° C.

In the present invention, the amount of residual solvents is defined by the following equation.

Amount of residual solvents (% by weight)={(M−N)/N}×100

where M is a mass of a sample sampled at any time point during or after the web or film production, and N is a mass after heating M at 115° C. for 1 hour.

In the step of drying the cellulose ester film, the web is peeled off the metal support, and further dried until the residual solvent decreases to 0.5% by weight or smaller.

In the film drying step, a drying system is generally employed such as a roll drying system (a web is passed alternately through a large number of rolls arranged up and down, for drying), or a tenter system while the web is being conveyed.

Since the web is stretched in the longitudinal direction by the peeling tension and the conveyance tension thereafter when the web is peeled off the metal support, it is preferable in the present invention that the peeling of the web off the cast support is carried out in the state that the peeling and conveyance tensions are reduced as much as possible. Specifically, the tension is effectively made to be, for example, 50 to 170 N/m or lower. At this time, the web is preferably exposed to cold air of 20° C. or lower to rapidly fix the web.

The above-described dried film, an unstretched raw film, is then stretched at a desired angle by the foregoing oblique stretching tenter according to the present invention to provide a polymer film.

<Polymer Film>

The polymer film according to the present invention is advantageously used as an optical film such as a polarizing plate protection film, a retardation film (including a λ/4 plate) and an antireflection film.

The polymer film according to the present invention preferably has an in-plane retardation value Ro(550) in the range of 110 to 170 nm as measured under the environment of 23° C. and 55% RH and at a wavelength of 550 nm. The in-plane retardation value Ro can be measured using an automatic birefringence analyzer. The measurement can be made under the environment of 23° C. and 55% RH.

The angle θ₁ formed by the in-plane slow axis (b) of the polymer film according to the present invention and the transverse direction (a) thereof satisfies preferably 40°≦θ₁≦50°, and more preferably 44°≦θ₁≦46°.

The thickness of the polymer film is not especially limited, but preferably 100 μm or smaller, more preferably 80 μm or smaller, and still more preferably 60 μm or smaller, in order to limit fluctuations in the retardation depending on conditions such as temperature and humidity. By contrast, the thickness of the polymer film is preferably 20 μm or larger, and more preferably 30 μm or larger, in order to secure the mechanical strength of the film.

<Functional Layers>

The polymer film according to the present invention may be provided with functional layer(s) such as a hard coat layer, an antistatic layer, a back coat layer, an antireflection layer, an easily slipping layer, an adhesive layer, an antiglare layer, and a barrier layer.

<Hard Coat Layer>

The polymer film according to the present invention may be provided with a hard coat layer. The hard coat layer contains a cured material of an active ray-curable resin, and preferably contains, as the main component, a cured resin that has undergone a crosslinking reaction by irradiation with active rays (also called active energy rays) such as ultraviolet rays and electron beams.

The hard coat layer can be formed by applying and drying a coating liquid for a hard coat layer containing an active ray-curable resin, a photopolymerization initiator, and as required, a microparticle, and thereafter subjecting the resultant to UV curing treatment.

As the active ray-curable resin, material containing a monomer having an ethylenically unsaturated double bond is advantageously employed. The active ray-curable resin is a resin that is curable by irradiation with active rays such as ultraviolet rays or electron beams.

Examples of the active ray-curable resin typically include ultraviolet ray-curable resins and electron beam-curable resins, but resins to be cured by an ultraviolet ray application are preferable from the viewpoint of the excellent mechanical film strength (scratch resistance and pencil hardness).

The ultraviolet ray-curable resins advantageously used are ultraviolet ray-curable urethane acrylate-based resins, ultraviolet ray-curable polyester acrylate-based resins, ultraviolet ray-curable epoxy acrylate-based resins, ultraviolet ray-curable polyol acrylate-based reins, ultraviolet ray-curable epoxy resins and the like. Above all, ultraviolet ray-curable acrylate-based resins are preferable.

The coating liquid for a hard coat layer preferably contains a photopolymerization initiator in order to promote curing of the active ray-curable resin. The photopolymerization initiator is preferably contained in an amount such that the mass ratio of the photopolymerization initiator to active ray-curable resin is in the range of 20:100 to 0.01:100.

Examples of the photopolymerization initiator specifically include acetophenone, benzophenone, hydroxybenzophenone. Michler's ketones, α-amyloxime esters, thioxanthone, and derivatives thereof, but the photopolymerization initiator is not especially limited thereto.

The coating liquid for a hard coat layer preferably contains microparticles of an inorganic compound or an organic compound.

Examples of the inorganic microparticle include silicon oxide, titanium oxide, aluminum oxide, tin oxide, indium oxide, ITO, zinc oxide, zirconium oxide, magnesium oxide, calcium carbonate, talc, clay, calcined kaolin, calcined calcium silicate, calcium silicate hydrate, aluminum silicate, magnesium silicate, and calcium phosphate. Especially preferable are silicon oxide, titanium oxide, aluminum oxide, zirconium oxide, magnesium oxide, and the like.

The organic particles which can be added are polymethacrylic acid methylacrylate resin powder, acrylic styrene-based resin powder, polymethyl methacrylate resin powder, silicon-based resin powder, polystyrene-based resin powder, polycarbonate resin powder, benzoguanamine-based resin powder, melamine-based resin powder, polyolefin-based resin powder, polyester-based resin powder, polyamide-based resin powder, polyimide-based resin powder, polyfluoroethylene-based resin powder, and the like.

The mean particle diameter of the above-mentioned microparticle powders is not especially limited, but is preferably 0.01 to 5 μm, and especially preferably 0.01 to 1.0 μm. The microparticle powder may contain two or more types of microparticles having different particle diameters. The mean particle diameter of the microparticle can be measured, for example, by a laser diffraction-type particle size distribution analyzer.

With respect to the proportions of an ultraviolet ray-curable resin compound and a microparticle, the microparticle is blended desirably in 10 to 400 parts by mass, and more desirably 50 to 200 parts by mass, based on 100 parts by mass of the resin composition.

The average film thickness as a dry film thickness of the hard coat layer is 0.1 to 30 μm, preferably 1 to 20 μm, and especially preferably 6 to 15 μm.

A light source for the UV curing treatment can be used without any limitation as long as the light source is one generating ultraviolet rays. Examples usable light sources include a low-pressure mercury lamp, a medium-pressure mercury lamp, a high-pressure mercury lamp, an ultrahigh-pressure mercury lamp, a carbon arc lamp, a metal halide lamp, and a xenon lamp.

Although the irradiation conditions differ for each type of the lamp, the exposure dose of active rays is usually 5 to 500 mJ/cm², and preferably 5 to 200 mJ/cm².

<Back Coat Layer>

The polymer film according to the present invention may be provided with a back coat layer on the surface opposite to the side provided with the hard coat layer, in order to prevent curling and adhesion.

Examples of particles of inorganic compounds to be added to the back coat layer include silicon dioxide, titanium dioxide, aluminum oxide, zirconium oxide, calcium carbonate, calcium carbonate, talc, clay, calcined kaolin, calcined calcium silicate, tin oxide, indium oxide, zinc oxide, ITO, calcium silicate hydrate, aluminum silicate, magnesium silicate, and calcium phosphate.

The particle contained in the back coat layer is preferably 0.1 to 50% by weight based on a binder. The increase in the haze in the case where a back coat layer is provided is preferably 1.5% or less, more preferably 0.5% or less, and especially preferably 0.1% or less.

<Antireflection Layer>

In the polymer film according to the present invention, an antireflection layer is applied on the hard coat layer, and the polymer film can be used as an antiretlection film having an external light reflection-preventive function.

The antireflection layer is preferably a laminate in consideration of the refractive index, the film thickness, the number of the layers, the order of the layers and the like so as to reduce the reflectance by optical interference. The antireflection layer is preferably constituted of a low-refractive index layer having a lower refractive index than the support or a combination of a high-refractive index layer having a higher refractive index than the support and a low-refractive index layer. Especially preferable is an antireflection layer constituted of three or more refractive index layers; it is preferable to employ a laminate in which three layers having different refractive indexes are laminated from the support side in the order of a medium refractive index layer (a layer having a higher refractive index than the support and a lower refractive index than a high-refractive index layer)/the high-refractive index layer/a low refractive index layer. Alternatively, an antireflection layer is advantageously used which has a four or more layers in which two or more high refractive index layers and two or more low-refractive index layers are alternately laminated.

As the layer constitution of the antireflection film, the following constitutions are conceivable, but the constitution is not limited thereto. Here, “/” indicates a lamination arrangement.

Polymer film/clear hard coat layer/low-refractive index layer

Polymer film/clear hard coat layer/high-refractive index layer/a low-refractive index layer

Polymer film/clear hard coat layer/medium-refractive index layer/high-refractive index layer/low-refractive index layer

Polymer film/antiglare hard coal layer/low-refractive index layer

Polymer film/antiglare hard coat layer/high-refractive index layer/low-refractive index layer

Polymer film/antiglare hard coat layer/medium-refractive index layer/high-refractive index layer/low-refractive index layer

A low-refractive index layer essential for an antireflection film preferably contains a silica-based microparticle, and has a lower refractive index than that of the support, for example, than that of a cellulose film, and preferably has a refractive index as measured at 23° C. at a wavelength of 550 nm in the range of 1.30 to 1.45.

The film thickness of the low-refractive index layer is preferably 5 nm to 0.5 μm, more preferably 10 nm to 0.3 μm, and most preferably 30 nm to 0.2 μm.

A composition for forming a low-refractive index layer preferably contains, as a silica-based microparticle, particularly at least one type of particles which have an outer shell layer and are porous or hollow inside. Particularly, the particle which has an outer shell layer and is porous or hollow inside is preferably a hollow silica-based microparticles.

The composition for forming a low-refractive index layer may concurrently contain an organosilicon compound represented by the following formula, its hydrolysate, or its polycondensate.

Si(OR)₄

In the above formula, R represents a C₁₋₄ alkyl group. Specific examples of organosilicon compounds represented by the above formula which are advantageously used are tetramethoxysilane, tetraethoxysilane, and tetraisopropoxysilnae.

Furthermore, a solvent, and as required, a silane coupling agent, a curing agent, a surfactant and the like may be added.

<Polarizing Plate>

The polymer film according to the present invention can be used for a polarizing plate in various types of modes according to the purpose. That is, the polarizing plate according to the present invention includes a polarizer and the polymer film according to the present invention disposed directly on at least one surface of the polarizer or with additional layer(s) being disposed between the polarizer and the polymer film. The polymer film according to the present invention is advantageously used as a λ/4 plate having the features described below.

In the present invention, a “λ/4 plate” refers to a plate having a function of converting linearly polarized light of a specific wavelength into circularly polarized light (or vice versa). The λ/4 plate is designed to exhibit an in-plane retardation value Ro of the layer of about ¼ for a predetermined wavelength of light (usually visible light region).

That is, the λ/4 plate is preferably a retardation plate exhibiting retardation of substantially ¼ of the wavelengths in the range of visible light wavelengths in order to acquire nearly complete circularly polarized light in the range of visible light wavelengths.

The “retardation of substantially ¼ of the wavelengths in the range of visible light wavelengths” means that retardation is larger at longer wavelengths in the wavelength range from 400 to 700 nm; and it is preferable that Ro(450) or in-plane retardation value represented by the following equation (i) as measured at a wavelength of 450 nm and Ro(590), an in-plane retardation value as measured at a wavelength of 590 nm satisfy 1<Ro(590)/Ro(450)≦1.6. Further in order for the polymer film to effectively function as a λ/4 plate, it is more preferable in the retardation film that Ro(450) is in the range of 100 to 125 nm, the retardation value Ro(550) as measured at a wavelength of 550 nm is in the range of 110 to 170 nm, and Ro(590) is in the range of 130 to 152 nm.

Ro=(nx−ny)×d Equation (i):

Rt={(nx+ny)/2−nz}×d Equation (ii):

In the equations, nx and ny are respective refractive indexes nx (a maximum refractive index in the plane of the film, also called a refractive index in the slow axis direction) and ny (a refractive index in the direction orthogonal to the slow axis direction in the plane of the film) at 23° C. and 55% RH, and at 450 nm, 550 nm and 590 nm; and d is a thickness (nm) of the film.

The in-plane retardation value Ro and the thickness direction retardation value Rt can be measured using an automatic birefringence analyzer. The retardation values at each wavelength are measured under the environment of 23° C. and 55% RH using an automatic birefringence analyzer KOBRA-21ADH (made by Oji Scientific Instruments).

The adjustment of the retardation values can be carried out by adjustment and control of constituents, compositions, stretching conditions and the like of the polymer film. The adjustment can be carried out also by addition of a retardation adjuster.

When the λ/4 plate and a polarizer described later are laminated so that the angle formed by the slow axis of the λ/4 plate and the transmission axis of the polarizer is substantially 45°, a circularly polarizing plate is obtained. “Substantially 45°” as used herein means 40 to 50°. The angle formed by the slow axis of the λ/4 plate and the transmission axis of the polarizer is preferably 41 to 49°, more preferably 42 to 48°, still more preferably 43 to 47°, and most preferably 44 to 46°.

The polarizer can be a film obtained by stretching a polyvinyl alcohol film doped with iodine or dichroic dye. Doping with iodine or the like can be carried out for example by immersing a polyvinyl alcohol-based film in iodine solution or the like.

The film thickness of the polarizer is 5 to 40 μm, preferably 5 to 30 μm, and especially preferably 5 to 20 μm.

Optical film (Y) may be disposed on the surface of the polarizer opposite to the surface on which the λ/4 plate is disposed. Optical film (Y) is preferably a polymer film, and is preferably easy to produce, uniform optically, and transparent optically. The polymer film may be any as long as having these properties, and examples include cellulose ester-based films, polyester-based films, polycarbonate-based films, polyarylate-based films, polysulfone-based (including polyether sulfone) films, polyester films such as polyethylene terephthalate and polyethylene naphthalate, polyethylene films, polypropylene films, cellophanes, cellulose diacetate films, cellulose acetate butylate films, polyvinylidene chloride films, polyvinyl alcohol films, ethylene vinyl alcohol films, syndiotactic polystyrene-based films, polycarbonate films, norbornene resin-based films, polymethylpentene films, polyether ketone films, polyether ketoneimide films, polyamide films, fluoropolymer films, nylon films, cycloolefin polymer films, polyvinyl acetal-based polymer films, polymethyl methacrylate films, and acrylic films, but the polymer film is not limited thereto.

In the case of cellulose ester-based films, advantageously used are the cellulose ester, plasticizers, ultraviolet absorbents, antioxidants, retardation adjusters, matte agents, anti-aging agents, peeling aids, surfactants, and the like to be used in the above-mentioned polymer film.

It is preferable that retardation values Ro and Rt of optical film (Y) disposed on the surface opposite to the surface on which the λ/4 plate is disposed are, respectively, 20 to 150 nm and 70 to 400 nm, or 0 nm≦Ro≦2 nm and −15 nm≦Rt≦15 nm.

Examples of optical film (Y) include optical films that include a support and an optically anisotropic layer provided on the support, which optical films are produced using for example a method in which a discotic liquid crystalline compound, a compound having a negative uniaxiality, is carried on a support (see, e.g., Japanese Patent O.P.I. Publication No. 7-325221), a method in which a nematic polymeric liquid crystalline compound having a positive optical anisotropy is hybrid-aligned so that the pretilt angle of the liquid crystal molecules is varied in the depth direction, and this liquid crystalline compound is carried on a support (see, e.g., Japanese Patent O.P.I. Publication No. 10-186356), a method in which a nematic liquid crystalline compound having a positive optical anisotropy is carried as two-layer constitution, and the alignment directions of the layers are made to be nearly 90° to thereby impart an optical property similar to a negative uniaxiality in a pseudo manner (see, e.g. Japanese Patent O.P.I. Publication No. 8-15681); optical films concurrently having a function of a retardation film by developing a retardation by stretching of a cellulose derivative film in place of a conventional TAC film and subjecting the stretched film to a saponification treatment and laminating a PVA polarizer (see, e.g. Japanese Patent O.P.I. Publication No. 2003-270442); and optical compensator films produced by adding a retardation adjuster to a cellulose ester film to provide a retardation film (see, e.g., Japanese Patent O.P.I. Publication Nos. 2000-275434 and 2003-344655); and so forth. However, the optical film (Y) is not limited these films.

Examples of commercially available cellulose ester films advantageously usable are Konica Minolta Tac KC8UX, KC4UX, KC5UX, KC8UCR3, KC8UCR4, KC8UCR5, KC8UY, KC4UY, KC12UR, KC16UR, KC4UE, KC8UE, KC4FR-1, and KC4FR-2 (all made by Konica Minolta Opto, Inc.).

A polarizing plate can be produced by laminating the λ/4 plate or polymer film according to the present invention, the polarizer, and optical film (Y). Specifically, it is preferable that the λ/4 plate or polymer film according to the present invention is subjected to an alkali saponification treatment, and thereafter laminated on at least one surface of the polarizer by using a completely saponified polyvinyl alcohol aqueous solution. It is preferable that optical film (Y) is laminated on the other surface of the polarizer.

The polarizing plate can be constituted by further laminating a protection film on one surface of the polarizing plate and a separate film on the opposite surface. The protection film and the separate film are used for the purpose of protecting the polarizing plate during its shipping, product inspection and the like.

<Liquid Crystal Display>

A liquid crystal display includes a liquid crystal cell and a pair of polarizing plates interposing the liquid crystal cell. At least one of the pair of polarizing plates can be made to be the above-mentioned polarizing plate according to the present invention. The polarizing plate according to the present invention includes the polarizer and the polymer film according to the present invention disposed at least on one surface of the polarizer, as described above.

The polymer film according to the present invention is advantageously used as a λ/4 plate as described above. In this case, the polarizing plate including the λ/4 plate according to the present invention is preferably disposed on the viewing-side surface of the liquid crystal cell. The λ/4 plate according to the present invention is preferably disposed on the viewing-side surface (the opposite-side surface to the liquid crystal cell) of the polarizer.

Liquid crystal cells which are advantageously used include reflection type, transmission type and semi-transmission type LCDs, and super twisted nematic (STN) mode, twisted nematic (TN) mode, in-plane switching (IPS) mode, vertical alignment (VA) mode, bend nematic (OCB: Optically Aligned Birefringence) mode, and hybrid alignment (HAN: Hybrid Aligned Nematic) mode LCDs.

### EXAMPLES

Hereinafter, the present invention will be described specifically by way of Examples, but the present invention is not limited thereto.

### Production Example 1

### <Fabrication of Roll-Shape Raw Film 1>

(Fabrication of Polyester A)

4.85 g of dimethyl terephthalate, 4.4 g of 1,2-propylene glycol, 6.8 g of p-toluic acid and 10 mg of tetraisopropyl titanate were mixed under a nitrogen atmosphere, stirred at 140° C. for 2 hours, and further stirred at 210° C. for 16 hours. Then, the solution was cooled to 170° C., and unreacted 1,2-propylene glycol was distilled away under reduced pressure to afford polyester A. Since a monocarboxylic acid is used in an amount two mole times the amount of a dicarboxylic acid, polyester A has a toluate at its terminals.

Acid value: 0.1

Number-average molecular weight: 490

Degree of dispersion: 1.4

Amount of components having a molecular weight of 300 to 1,800: 90%

Hydroxyl value: 0.1

Amount of hydroxyl group: 0.04%

<Microparticle Dispersion Liquid 1>

Microparticle (Aerosil R812, made by Nippon Aerosil Co., Ltd.): 11 parts by mass

Ethanol: 89 parts by mass

The above components were stirred and mixed for 50 min by a dissolver, and thereafter dispersed by a Manton Gaulin.

<Microparticle-Added Liquid 1>

Microparticle dispersion liquid 1 was slowly added under sufficient stirring to a dissolution tank charged with methylene chloride. Microparticle dispersion liquid 1 was dispersed by Attritor so that the particle diameter of the secondary particle had a predetermined size. The dispersion was filtered by a Fine Met NF made by Nippon Seisen Co., Ltd. to thereby prepare microparticle-added liquid 1.

Methylene chloride: 99 parts by mass

Microparticle dispersion liquid 1: 5 parts by mass

A main dope liquid having the following composition was prepared. First, methylene chloride and ethanol were added to a pressurized dissolution tank. A cellulose ester was charged under stirring to the pressurized dissolution tank charged with the solvents. The mixture was heated under stirring to thereby completely dissolve the mixture. The obtained solution was filtered using Azumi filter paper No. 244 made by Azumi Filter Paper Co., Ltd. to thereby prepare a main dope liquid.

### <Composition of Main Dope Liquid>

Methylene chloride: 340 parts by mass

Ethanol: 64 parts by mass

Cellulose ester (cellulose diacetate: the degree of substitution with an acetyl group: 2.4, that with a propionyl group: 0, the total degree of substitution: 2.4): 100 parts by mass

Saccharide ester compound A described below: 7.0 parts by mass

Polyester A: 2.5 parts by mass

TINUVIN 928 (made by BASF Japan Ltd.): 1.5 parts by mass

Microparticle-added liquid 1: 1 part by mass

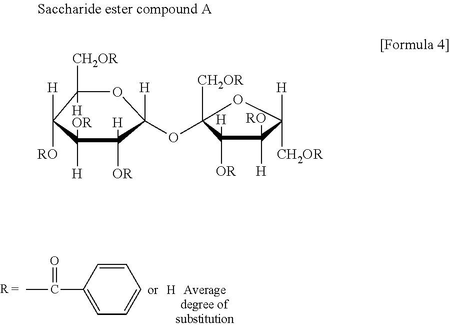

The above substances were charged in a closed vessel, and dissolved under stirring to thereby prepare a dope liquid.

Then, the dope liquid was cast uniformly at 33° C. in a 1,500-mm width on a stainless steel belt support by using an endless belt casting apparatus. The temperature of the stainless steel belt was controlled at 30° C. The solvent was evaporated on the stainless steel belt support until the residual solvent amount in the cast film amounted to 75%, and then, the film was peeled off the stainless steel belt support with a peeling tension of 110 N/m. The peeled cellulose ester film was stretched by 5% in the width direction under heating at 160° C. by using a tenter. The residual solvent at the start of the stretching was 15%. Then, drying of the cellulose ester film was finished while the cellulose ester film was conveyed through a number of rolls in a drying zone. The drying temperature was set at 130° C. and the conveyance tension was set at 100 N/m. In the same manner as described above, roll-shape raw film 1 having an average dried film thickness of 75 μm is obtained.

The thickness unevenness in the longitudinal direction of obtained raw film 1 was 0.15 μm, and the thickness unevenness in the transverse direction thereof was 0.15 μm. The in-plane retardation and thickness-direction retardation at a wavelength of 550 nm were measured by the abovementioned method and Ro(550) was 10 nm, and Rt(550) was 120 nm.

### Production Example 2

### <Fabrication of Roll-Shape Raw Film 2>

Roll-shape raw film 2 was obtained as in Production Example 1, except for altering the cellulose ester in Production Example 1 to a cellulose acetate propionate having a degree of substitution with an acetyl group of 1.5, that with a propionyl group of 0.9, and a total degree of substitution of 2.4.

Raw film 2 had an average dried film thickness of 76 μm, a thickness unevenness in the longitudinal direction of 0.15 μm, and a thickness unevenness in the transverse direction of 0.15 μm. The in-plane retardation value Ro(550) and the thickness-direction retardation value Rt(550) at a wavelength of 550 nm were 10 nm and 118 nm, respectively.

### Production Example 3

### (Synthesis of Acrylic Polymer)

In a glass flask with a stirrer, two dropping funnels, a gas introduction tube and a thermometer, 28 g of methyl methacrylate, 12 g of N-vinylpyrrolidone, 2 g of mercaptopropionic acid as a chain transfer agent, and 30 g of toluene were charged, and heated to 90° C. Thereafter, from one dropping funnel, 60 g of a mixed liquid of 42 g of methyl methacrylate and 18 g of N-vinylpyrrolidone was dropwise charged over 3 hours; and simultaneously from the other dropping funnel, 0.4 g of azobisisobutyronitrile dissolved in 14 g of toluene was dropwise charged over 3 hours. Thereafter, 0.6 g of azobisisobutyronitrile dissolved in 56 g of toluene was further dropwise charged over 2 hours; and the reaction was continued further for 2 hours to thereby obtain a polymer. The obtained polymer was solid at normal temperature. Then, by altering the amount of mercaptopropionic acid to be added as a chain transfer agent and the addition speed of azobisisobutyronitrile, a polymer having a different molecular weight was fabricated. The weight-average molecular weight of the polymer was 10,000 by the following measurement method.

(Weight-Average Molecular Weight)

The weight-average molecular weight of the polymer was determined in terms of polystyrene by GPC described above.

### Production Example 4

### <Fabrication of a Roll-Shape Raw Film 3>

(Preparation of a Dope Liquid)

A cellulose ester (cellulose acetate propionate: the degree of substitution with an acetyl group: 0.05, that with a propionyl group: 1.89, the total degree of substitution: 1.94, vacuum dried at a temperature of 60° C. for 24 hours): 70 parts by mass

Acrylic polymer fabricated in Production Example 3: 30 parts by mass

TIINUVIN 928 (made by BASF Japan Ltd.): 1.5 parts by mass

Silicon oxide microparticle (Aerosil R972V (Nippon Aerosil Co., Ltd.)): 0.1 parts by mass

Methylene chloride: 300 parts by mass

Ethanol: 40 parts by mass

A dope liquid having the above composition was produced, and was then filtered by Fine Met NF made by Nippon Seisen Co., Ltd., and was cast uniformly at a temperature of 22° C. in a 2-m width on a stainless steel band support by using a belt casting apparatus.

The solvent was evaporated on the stainless steel band support until the residual solvent amount amounted to 100%, and then, the obtained film was peeled off the stainless steel band support at a peeling tension of 162 N/m. The solvent in the peeled web of cellulose ester was evaporated at 35° C., and the web was slit into a width of 1.6 m, and thereafter dried at a drying temperature of 135° C. in a tenter while being stretched to 1.05 times. At this time, the residual solvent amount at the start of stretching by the tenter was 10%. After the stretching by the tenter, the film was relaxed at 130° C. for 5 min, and drying of the film was finished while the film was being conveyed through a number of rolls in drying zones at 120° C. and 130° C.; the film was slit into a width of 1.5 m, and both ends of the film was subjected to a knurling processing of 10 mm in width and 5 μm in height; and the film was taken up at an initial tension of 220 N/m and a final tension of 110 N/m on a core of 6 inches in inner diameter to thereby obtain a roll-shape raw film 3. The stretching ratio in the MD direction calculated from the rotation velocity of the stainless steel band support and the driving velocity of the tenter was 1.01 times. Raw film 3 having an average dried film thickness of 76 μm and the number of winding corresponding to 4,000 m was obtained.

The thickness unevenness in the longitudinal direction and that in the transverse direction of obtained raw film 3 were 0.15 μm and 0.15 μm, respectively. The in-plane retardation value Ro(550) and the thickness-direction retardation value Rt(550) at a wavelength of 550 nm were 5 nm and 115 nm, respectively.

### Production Example 5

### <Fabrication of Roll-Shape Raw Film 4>

In a 30-L reaction vessel with a stirring apparatus, a temperature sensor, a cooling tube and a nitrogen introduction tube, 7,000 g of methyl methacrylate (MMA), 3,000 g of methyl 2-(hydroxymethyl)acrylate (MHMA), and 12.000 g of toluene were charged, and heated to 105° C. and retfluxed under the introduction of nitrogen; then, 6.0 g of t-amyl peroxyisononanoate as an initiator (Lupasol 570, made by Arkema Yoshitomi, Ltd.) was added and while a solution composed of 12.0 g of t-amyl peroxyisononanoate and 100 g of toluene simultaneously was started to be dropwise charged and dropwise charged over 2 hours, the solution polymerization under reflux (about 105 to 110° C.) was carried out, and aging was further carried out over 4 hours. The reaction ratio of the polymerization was 92.9%, and the content (mass ratio) of MHMA in the polymer was 30.2%.

To the obtained polymer solution, 20 g of an octyl phosphate/dioctyl phosphate mixture (trade name: Phoslex A-8, made by Sakai Chemical Industry Co., Ltd.), and the cyclization condensation reaction under reflux (about 80 to 105° C.) was carried out for 2 hours, and 4,000 g of methyl ethyl ketone was added for dilution. The cyclization condensation reaction under pressure (the gauge pressure was about 2 MPa at highest) was carried out for 1.5 hours in an autoclave using a heat medium at 240° C.

Then, the polymer solution obtained by the cyclization condensation reaction was heated to 220° C. through a heat exchanger, and thereafter introduced at a processing rate of 15 kg/hr in terms of resin amount to a vent-type twin-screw extruder (diameter=42 mm, L/D=42) having one rear vent and four fore vents to carry out the cyclization condensation reaction and the devolatilization in the extruder. The cylinder temperature of the extruder was set at 250° C.; the rotation frequency, at 170 rpm; and a degree of reduced pressure, 13.3 hPa to 400 hPa (10 mmHg to 300 mmHg). To the middle of a first fore vent and a second fore vent, a solution composed of 26.5 g of zinc octylate (Nikka Octhix Zinc 18%, made by Nihon Kagaku Sangyo Co., Ltd.), 2.2 g of IRGANOX 1010 (made by BASF Japan Ltd.) and 2.2 g of Adeka Stab AO-412S (made by Adeka Corp.) as antioxidants, and 61.6 g of toluene was injected at a rate of 20 g/hr. A polymer solution after the devolatilization operation in the extruder was extruded to thereby obtain a transparent pellet.

The obtained pellet was measured for a dynamic TG and a mass loss of 0.21% by weight was detected. The weight-average molecular weight of the pellet was 110,000; and the melt flow rate was 8.7 g/10 min; and the glass transition temperature was 142° C.

Then, the pellet was extruded and formed under the following condition using a single-screw extruder having a cylinder diameter of 20 mm to thereby afford raw film 4 having an average film thickness of 74 μm.

Cylinder temperature: 280° C.

Die: coat hanger-type, temperature: 290° C.

Casting: glazed two rolls, temperature of the first roll and second roll was 130° C.

The thickness unevenness in the longitudinal direction and the thickness unevenness in the transverse direction of obtained raw film 4 were 0.15 μm and 0.15 μm, respectively. The in-plane retardation value Ro(550) and the thickness-direction retardation value Rt(550) at a wavelength of 550 nm were 5 nm and 0 nm, respectively.

### Production Example 6

### <Fabrication of Roll-Shape Raw Film 5>

A pellet of a norbornene-based resin (ZEONOR 1420: glass transition temperature=137° C., made by ZEON Corp.) was dried at 100° C. for 5 hours. The pellet was fed to an extruder having a cylinder diameter of 20 mm, melted in the extruder, extruded in a sheet form through a polymer pipe and a polymer filter from a T die on a casting drum, and cooled to afford raw film 5 having a thickness of 75 μm. The in-plane retardation value Ro(550) and the thickness-direction retardation value Rt(550) at a wavelength of 550 nm were 5 nm and 1 nm, respectively.

### Example 1

Raw film 1 was stretched using off-line stretching apparatus 1 illustrated in FIG. 1.

First, raw film 1 was mounted on roll mounting shaft 10 of film delivery apparatus 13, and set on the delivery position, and thereafter conveyed through accumulation section 4, tenter section 5, trimming section 6, thermal relaxation section 7 and cooling section 8, and taken up in a roll-shape by takeup section 9. A sufficient loop was made in accumulation section 4. Oblique stretching was carried out at a stretching temperature of 175° C. and at a stretching ratio of 1.5 times in the tenter section.

The average film thickness of the obtained polymer film was 50 μm; and the in-plane retardation value Ro(550) at a wavelength of 550 nm was 140 nm. The angle θ₁ formed by the in-plane slow axis (b) of the obtained polymer film and the transverse direction (a) of the polymer film was 45°.

Then, a fresh roll of raw film 1 was mounted on mounting shaft 10 at the winding core exchange position; after the film of the roll at the delivery position was consumed, the turret arm was rotated by 180°, and fresh raw film 1 was set on the delivery position, and conveyed to joining area 3. The raw films were joined along the joining line by travelling a spot-type ultrasonic welder in joining area 3.

In the joining of the raw films, the angle φ₀ formed by the joining line (f) of the raw films and the transverse direction (a) of the raw films was made to be 0°. The ultrasonic welder had a spot diameter of 1.7 mm. The width of the joining line of the joining portion (fusing portion) of the raw films was 1.7 mm. The degree of pressurization of the welder was adjusted so that the total thickness of the joining portion of the raw films became 105 μm. In later tenter section 5, both end portions in the transverse direction of the joining portion of the raw films chucked by the holding implements (clips) were twice treated along the same joining line by the ultrasonic welder to thereby make the total thickness of the joining portion of the raw films to be 94 μm. The melted resin protruding from both the end portions in the transverse direction of the fusing portion of the raw films was cut by a laser cutter.

Since the raw film accumulated in accumulation section 4 was fed to tenter section 5 during the joining work, tenter section 5 was not suspended. Joined raw film 1 was conveyed through accumulation section 4 to tenter section 5.

In tenter section 5, the joining portion of the raw films was stretched in the oblique direction as with portions around the joining portion, and caused no defects such as rupture.

After the stretching, the angle φ₁ formed by the joining line (f) and the transverse direction (a) of the obtained polymer film was 45°.

### Example 2

Oblique stretching was continuously carried out using raw film 2 by the similar method as in Example 1. After the stretching, the average film thickness of the obtained polymer film was 50 μm; the in-plane retardation value Ro(550) was 135 nm; and θ₁ was 44°. The total thickness of the joining portion of the raw films was 109 μm. After the stretching, the angle φ₁ formed by the joining line (f) and the transverse direction (a) of the obtained polymer film was 45°.

### Example 3

Oblique stretching was continuously carried out using raw film 3 as in Example 1, except for altering the stretching temperature to 145° C. After the stretching, the average film thickness of the obtained polymer film was 51 μm; the in-plane retardation value Ro(550) was 140 nm; and θ₁ was 45°. The total thickness of the joining portion of the raw films was 109 μm. After the stretching, the angle φ₁ formed by the joining line (f) and the transverse direction (a) of the obtained polymer film was 45°.

### Example 4

Oblique stretching was continuously carried out using raw film 4 as in Example 1, except for altering the stretching temperature to 155° C. After the stretching, the average film thickness of the obtained polymer film was 50 μm; the in-plane retardation value Ro(550) was 140 nm; and θ₁ was 45°. The total thickness of the joining portion of the raw films was 105 μm. After the stretching, the angle φ₁ formed by the joining line (f) and the transverse direction (a) of the obtained polymer film was 46°.

### Example 5

Oblique stretching was continuously carried out using raw film 5 as in Example 1, except for altering the stretching temperature to 145° C. After the stretching, the average film thickness of the obtained polymer film was 51 μm; the in-plane retardation value Ro(550) was 140 nm; and θ₁ was 46°. The total thickness of the joining portion of the raw films was 105 μm. After the stretching, the angle φ₁ formed by the joining line (f) and the transverse direction (a) of the obtained polymer film was 47°.

<<Evaluations>>

The long-sized polymer films (λ/4 plates) having a joining portion, obtained in Examples 1 to 5, were evaluated as follows.

The twitches of the obtained polymer film were evaluated according to the following standard, the twitches of the polymer film occurring at positions 1.5 m apart in the film conveyance direction and in the opposite direction from the central portion in the film transverse direction of the joining line (f) of the polymer film.

S: No twitch is observed at any position in the transverse direction of the film.

A: Weak twitch is partially observed, but to the extent that is not problematic.

B: Weak twitch is overall observed, but does not make a cause of defects such as rupture, and the film practically acceptable.

C: Twitch is clearly observed, and makes the cause of rupture.

The easiness of rupture caused at the joining portion of the polymer film was evaluated according to the following standard.

A: No rupture occurred.

B: Rupture caused by the joining portion occurred very rarely.

C: Rupture caused by the joining portion occurred frequently.

Evaluation results of the above are shown in Table 1.

TABLE 1

| | Ex. 1 | Ex. 2 | Ex. 3 | Ex. 4 | Ex. 5 |
|---|---|---|---|---|---|
| Raw Film No. | 1 | 2 | 3 | 4 | 5 |
| Raw Film Thickness [μm] | 75 | 76 | 76 | 74 | 75 |
| In-Plane Retardation Ro | 140 | 135 | 140 | 140 | 140 |
| (550) [nm] | | | | | |
| Angle (after stretching) θ₁ | 45 | 44 | 45 | 45 | 46 |
| formed by Slow Axis (b) and | | | | | |
| Transverse Direction (a) [°] | | | | | |
| Joining means | Ultrasonic | Ultrasonic | Ultrasonic | Ultrasonic | Ultrasonic |
| | fusion | fusion | fusion | fusion | fusion |
| Width of Joining Line [mm] | 1.7 | 1.7 | 1.7 | 1.7 | 1.7 |
| Total Thickness of Fusing | 105 | 109 | 109 | 105 | 105 |
| Portion [nm] | | | | | |
| Angle (after stretching) φ₁ | 45 | 45 | 45 | 46 | 47 |
| formed by Joining Line (f) and | | | | | |
| Transverse Direction (a) [°] | | | | | |
| \|φ₁ − θ₁\| [°] | 0 | 1 | 0 | 1 | 1 |
| Twitch of Film | S | S | S | S | S |
| Rupture | A | A | A | A | A |

Oblique stretching was continuously carried out using raw film 1 as in Example 1, at a stretching temperature of 175° C. The in-plane retardation value Ro(550) of the obtained polymer film was 141 nm; and θ₁ was 41°. The total thickness of the joining portion of the raw films was 105 μm. After the stretching, the angle φ₁ formed by the joining line (f) and the transverse direction (a) of the obtained polymer film was 45°, and |φ₁−θ₁| was 4°.

### Example 7

Oblique stretching was continuously carried out using raw film 1 as in Example 6. The in-plane retardation value Ro(550) of the obtained polymer film was 140 nm; and θ₁ was 49°. The total thickness of the joining portion of the raw films was 105 μm. After the stretching, the angle φ₁ formed by the joining line (f) and the transverse direction (a) of the obtained polymer film was 44°, and |φ₁−θ₁| was 5°.

### Example 8

Oblique stretching was continuously carried out using raw film 1 as in Example 6. The in-plane retardation value Ro(550) of the obtained polymer film was 143 nm. The total thickness of the joining portion of the raw films was 105 μm. After the stretching, the angle φ₁ formed by the joining line (f) and the transverse direction (a) of the obtained polymer film was 52°, the angle θ₁ formed by the in-plane slow axis (b) and the transverse direction (a) of the polymer film was 44°, and |φ₁−θ₁| was 8°.

### Comparative Example 1

Oblique stretching was continuously carried out using raw film 1 as in Example 6, except for carrying out the joining so that φ₀ became −10° in the joining area. The in-plane retardation value Ro(550) of the obtained polymer film was 137 nm. The total thickness of the joining portion of the raw films was 106 μm. After the stretching, the angle φ₁ formed by the joining line (f) and the transverse direction (a) of the obtained polymer film was 33°, θ₁ was 450, and |φ₁−θ₁| was 13°.

<<Evaluations>>

The easiness of the occurrence of twitch and rupture of the long-sized polymer films (λ/4 plates) having a joining portion, obtained in Examples 6 to 8 and Comparative Example 1, was evaluated as in Examples 1 to 5. Evaluation results are shown in Table 2.

TABLE 2

| | Ex. 6 | Ex. 7 | Ex. 8 | Comp. Ex. 1 |
|---|---|---|---|---|
| Raw Film No. | 1 | 1 | 1 | 1 |
| Raw Film Thickness [μm] | 75 | 75 | 75 | 75 |
| In-Plane Retardation Ro | 141 | 140 | 143 | 137 |
| (550) [nm] | | | | |
| Angle (after stretching) θ₁ | 41 | 49 | 44 | 46 |
| formed by Slow Axis (b) and | | | | |
| Transverse Direction (a) [°] | | | | |
| Joining means | Ultrasonic | Ultrasonic | Ultrasonic | Ultrasonic |
| | fusion | fusion | fusion | fusion |
| Width of Joining Line [mm] | 1.7 | 1.7 | 1.7 | 1.7 |
| Total Thickness of Fusing | 105 | 105 | 105 | 106 |
| Portion [nm] | | | | |
| Angle (after stretching) φ₁ | 45 | 44 | 52 | 33 |
| formed by Joining Line (f) and | | | | |
| Transverse Direction (a) [°] | | | | |
| \|φ₁ − θ₁\| [°] | 4 | 5 | 8 | 13 |
| Twitch of Film | S | S | A | C |
| Rupture | A | A | A | C |

In the polymer film having a joining portion of Comparative Example 1, twitch was clearly observed allover, and rupture was apt to occur at the time of stretching.

### Example 9

Oblique stretching was continuously carried out using raw film 1 as in Example 6, except for altering the spot diameter of the ultrasonic welder to 4.8 mm. The width of the joining line of the raw films was 4.8 mm, and the total thickness of the joining portion of the raw films was 68 μm. After the stretching, the in-plane retardation value Ro(550) of the obtained polymer film was 142 nm, and θ₁ was 46°. The angle φ₁ formed by the joining line (f) and the transverse direction (a) of the polymer film was 47°, and |φ₁−θ₁| was 1°.

### Example 10

Oblique stretching was continuously carried out using raw film 1 as in Example 6, except for using two adjacent ultrasonic welders having a spot diameter of 4.8 mm. The width of the joining line of the raw films was 9.6 mm, and the total thickness of the joining portion of the raw films was 64 μm. After the stretching, the in-plane retardation value Ro(550) of the obtained polymer film was 139 nm, and θ₁ was 45°. The angle φ₁ formed by the joining line (f) and the transverse direction (a) of the polymer film was 45°, and |φ₁−θ₁| was 0°.

### Example 11

Oblique stretching was continuously carried out using raw film 1 as in Example 6, except for using an ultrasonic welder having a spot diameter of 1.7 mm. By adjusting the degree of pressurization of the welder, the total thickness of the joining portion of the raw films was made to become 78 μm. After the stretching, the in-plane retardation value Ro(550) of the obtained polymer film was 137 nm, and θ₁ was 44°. The angle φ₁ formed by the joining line (f) and the transverse direction (a) of the polymer film was 46°, and |φ₁−θ₁| was 2°.

### Example 12

Oblique stretching was continuously carried out using raw film 1 as in Example 6, except for using a double-sided tape composed of a polyester base material for joining. The width of the joining line (a portion joined by a tape) of the raw films was 12 mm, and the total thickness of the joining portion (the portion joined by the tape) of the raw films was 125 μm. After the stretching, the in-plane retardation value Ro(550) of the obtained polymer film was 141 nm, and θ₁ was 45°. The angle φ₁ formed by the joining line (f) and the transverse direction (a) of the polymer film was 48°, and |φ₁−θ₁| was 3°.

### Example 13

Oblique stretching was continuously carried out using raw film 1 as in Example 6, except for using a heat sealer for joining. The width of the joining line of the raw films was 7.0 mm, and the total thickness of the joining portion of the raw films was 83 μm. After the stretching, the in-plane retardation value Ro(550) of the obtained polymer film was 137 nm, and θ₁ was 45°. The angle φ₁ formed by the joining line (f) and the transverse direction (a) of the polymer film was 43°, and |φ₁−θ₁| was 2 °.

<<Evaluations>>

The easiness of the occurrence of twitch and rupture of the polymer films (λ/4 plates) having a joining portion, obtained in Examples 9 to 13, were evaluated as in Examples 1 to 5. Evaluation results are shown in Table 3.

TABLE 3

| | Ex. 9 | Ex. 10 | Ex. 11 | Ex. 12 | Ex. 13 |
|---|---|---|---|---|---|
| Raw Film No. | 1 | 1 | 1 | 1 | 1 |
| Raw Film Thickness [μm] | 75 | 75 | 75 | 75 | 75 |
| In-Plane retardation Ro | 142 | 139 | 137 | 141 | 137 |
| (550) [nm] | | | | | |
| Angle (after stretching) θ₁ | 46 | 45 | 44 | 45 | 45 |
| formed by Slow Axis (b) and | | | | | |
| Transverse Direction (a) [°] | | | | | |
| Joining means | Ultrasonic | Ultrasonic | Ultrasonic | Joining | Thermal |
| | fusion | fusion | fusion | tape | fusion |
| Width of Joining Line [mm] | 4.8 | 9.6 | 1.7 | 12.0 | 7.0 |
| Total Thickness of Fusing | 68 | 64 | 78 | 125 | 83 |
| Portion [nm] | | | | | |
| Angle (after stretching) φ₁ | 47 | 45 | 46 | 48 | 43 |
| formed by Joining Line (f) and | | | | | |
| Transverse Direction (a) [°] | | | | | |
| \|φ₁ − θ₁\| [°] | 1 | 0 | 2 | 3 | 2 |
| Twitch of Film | A | B | A | B | B |
| Rupture | A | B | A | B | B |

It has been found that in the case where the width of the joining line of the raw films was wide, and in the case where the total thickness of the joining portion of the raw films was large, twitch was liable to be generated and rupture was liable to occur.

It has been found from the results shown in the above Tables 1 to 3 that the means according to the present invention can limit the generation of twitch or rupture, and can provide a method for producing a long-sized polymer film, which enables continuous oblique stretching. It has been also found that a long-sized polymer film generating no twitch and no rupture can be provided.

The present application claims priority of Japanese Patent Application No. 2010-236251, filed on Oct. 21, 2010, the entire contents of which including the specification and the drawings are hereby incorporated by reference.

### INDUSTRIAL APPLICABILITY

The present invention can limit the generation of twitch or rupture, and can provide a method for producing a long-sized polymer film, which enables continuous oblique stretching.

### REFERENCE SIGNS LIST

1 Off-line stretching apparatus
2 Feed section
3 Joining area
4 Accumulation section (Accumulator section)
5 Tenter section
6 Trimming section
7 Thermal relaxation section
8 Cooling section
9 Takeup section
10 Mounting shaft
11 Film roll
12 Turret arm
13 Film delivery apparatus
14 Tenter
15-1 LD-SIDE FILM-HOLDING STARTING-POINT
15-2 SD-side film-holding starting-point
16-1 LD-side film-holding finishing-point
16-2 SD-side film-holding finishing-point
17-1 Track of LD-side film holding sections
17-2 Track of SD-side film holding sections
18 Film feed direction
19-1 Tenter inlet-side guide roll
19-2 Tenter outlet-side guide roll
a Film transverse direction
b In-plane slow axis
c Film conveyance direction
d Preceding raw film
e Following raw film
f Joining line
g Joining portion
φ0 Angle formed by joining line (f) and film transverse direction (a) before stretching
φ1 Angle formed by joining line (f) and film transverse direction (a) after stretching
θ1 Angle formed by in-plane slow axis (b) and film transverse direction (a) after stretching
SD Small turn-side of oblique stretching apparatus
LD Large turn-side of oblique stretching apparatus

1. A method for producing a long-sized polymer film, comprising:
(1) overlapping and joining a rear end portion of a preceding raw film and a front end portion of a following raw film along a joining line;
(2) heating the joined raw film, supporting both end portions thereof by a plurality of holding implements and obliquely stretching the raw film under continuous conveyance of the raw film to thereby make a polymer film; and
(3) subjecting the polymer film to a heat treatment for stress relaxation under continuous conveyance of the polymer film,
wherein the oblique stretching is carried out so that an angle formed by an in-plane slow axis of the polymer film obtained after the oblique stretching and the transverse direction of the polymer film obtained after the oblique stretching is in the range of 40 to 50°; and
the joining of the rear end portion of the preceding raw film and the front end portion of the following raw film is carried out so that an angle φ₁ formed by the joining line of the polymer film and the transverse direction of the polymer film and an angle θ₁ formed by the in-plane slow axis of the polymer film and the transverse direction of the polymer film satisfy the following equation (1):

|φ₁−θ₁|≦10° Equation (1):.

2. The method for producing a long-sized polymer film according to claim 1, wherein an angle φ₀ formed by the joining line of the raw film and the transverse direction of the raw film is made in the range of larger than −10° and 25° or smaller.

3. The method for producing a long-sized polymer film according to claim 1, wherein a width of the joining line of a joining portion of the rear end portion of the preceding raw film and the front end portion of the following raw film is 5 mm or smaller.

4. The method for producing a long-sized polymer film according to claim 1, wherein a total thickness of the joining portion of the rear end portion of the preceding raw film and the front end portion of the following raw film is within 1.1 to 1.5 times an average film thickness of the raw films.

5. The method for producing a long-sized polymer film according to claim 1, wherein the rear end portion of the preceding raw film and the front end portion of the following raw film are joined by fusion using an ultrasonic vibration.

6. A polymer film produced by a method for producing a long-sized polymer film according to claim 1, wherein an in-plane retardation value Ro(550) measured under an environment of 23° C. and 55% RH and at a wavelength of 550 nm is in the range of 110 to 170 nm.

7. A λ/4 plate, comprising the polymer film according to claim 6.

8. A polarizing plate comprising:
a polarizer; and
the polymer film according to claim 6 disposed on at least one surface of the polarizer.

9. A liquid crystal display comprising a liquid crystal cell and a pair of polarizing plates interposing the liquid crystal cell,
wherein at least one of the pair of polarizing plates comprises a polarizer and the polymer film according to claim 6 disposed on at least one surface of the polarizer.
